(19) United States
(12) Patent Application Publication
(10) Pub. No.: US 2010/0198423 A1
(43) Pub. Date: Aug. 5, 2010

(54) OPTIMISATION OF USE OR PROVISION OF A RESOURCE OR SERVICE

(75) Inventor: David R. Hirst, East Sussex (GB)

Correspondence Address: ALIX YALE & RISTAS LLP, 750 MAIN STREET, SUITE 1400, HARTFORD, CT, 06103, US

(73) Assignee: RESPONSIVELOAD LIMITED, Brighton (GB)

(21) Appl. No.: 12/311,806

(22) PCT Filed: Sep. 7, 2007
(86) PCT No.: PCT/EP2007/007842

§ 371 Date: Apr. 19, 2010

(30) Foreign Application Priority Data
Oct. 13, 2006 (GB) 0620401.0

(51) Int. Cl. G06F 1/28; G06Q 10/00; G06Q 50/00; G06F 17/00

(52) U.S. Cl. 700/292; 705/348; 705/8; 700/297; 700/90; 705/412

(57) ABSTRACT

A method and apparatus is provided in which the use or provision of a resource or service can be optimised based on data indicative of the benefits of using or providing the resource or service at one or more future times. The service could be the provision of electricity to an appliance or device. A retailer or distributor of the electricity could transmit future prices of the electricity based on the expected supply and demand for the electricity. An apparatus could receive the future prices and set a timing of an appliance or device to use or provide the electricity in order to optimise the cost of the use or provision of electricity. Other resources and services are also applicable, such as road network usage, telecoms or gas provision or usage. The usage or provision of the resource or service by the appliance or device can be metered and the amount of resource or service used or provided can be billed using the given indication of a benefit at particular future times, e.g. using the given future prices.

### FIELD OF THE INVENTION

The present invention is concerned with the control of a device or appliances that consume or produce a resource or service.

### BACKGROUND

The resources or services envisaged herein are utilities such as electricity, gas, water, heat, telecommunications and road space. The description that follows uses electricity as the exemplar resource, but the invention is applicable to other utilities, services etc. and the description is extended to give examples of the utilities at various places.

Most appliances consuming electricity operate so as to provide their service as soon as it is requested. A washing machine, for example, starts running as soon as the start button is pressed. Users will, without any motivation to do otherwise, generally operate their appliances at the most convenient time of day, and some times of day are generally more convenient for a majority of the population. This can lead to a population of appliances all being operated at “peak” times, and very few at other times. This results in electricity consumption that varies greatly over a given 24 hour period. In the UK, the demand at low demand times is about two thirds of the demand at high peak times. This profile of consumption means that there are times when the supply network is under particular stress, and other times when less electricity is required than is available to be generated resulting in inefficiencies.

Most domestic electricity markets operate fixed rate tariffs, so that all electricity consumed in a period—usually a month or longer—is paid for at the same rate per kWh, sometimes enhanced by time of day rates that differentiate between higher and lower priced times, e.g. day and night. While a dual pricing scheme does provide some incentive to more uniformly distribute demand, it is not enough. Furthermore, such pricing does not reflect the costs faced by those who supply the electricity, which vary over far shorter periods, sometimes with quite short peaks needing high priced electricity to cover it.

The prior art thus suffers a problem with inflexible tariffs. The present invention aims to provide a system allowing more flexible pricing of a resource or service, thereby allowing improved response to supply and demand on the market or network. Such tariffs are not restricted to electricity as will become apparent.

Variation of electricity demand and supply throughout a day is problematic for the network and for suppliers. In order to compensate for short term variation and to cover contingencies, such as the breakdown of a generation plant or transmission line, plant may be provided that can adjust output quickly. Such rapid output variation can be provided by highly flexible generation plant running at partial load. Operating in such a way as to have spare capacity is, however, inefficient. Furthermore, such plant is often “high carbon”. Both of these problems will result in emissions damaging the environment.

The supply of electricity may also naturally vary. The use of natural sources of electricity generation, such as wind, tidal and solar, mean that the supply of electricity is dependant on uncontrollable conditions. Unless influenced to do so, the demand will not, however, follow this supply and there is thus a certain inflexibility in the present system.

Other resources or service, such as other utilities or use of a road network, may suffer from similar problems in that use (consumption) varies significantly in both the short term and the long term and this variation makes the use or provision (generation) of the resource or service inefficient. It is a primary object of the present invention to provide an improved control of load on the resource or service so as to counter this variation and provide a smoother use (consumption) or provision of the resource or service, allowing appliance or devices to respond to the needs of the system as a whole, whereby the user of the appliance or device also benefits from such responsive use.

At present, a supply side electricity grid management system is used, in the UK at least. This approach controls a small number of larger generating units (a few hundred) and, in terms of keeping the system relatively stable, this is manageable. Such a system resists the use of a decentralised system with many generating units because the system would become unmanageable. However, there are efficiency advantages associated with a more decentralised system.

One example of use of small units to generate would be a combined heat and power plant. Such a plant produces electricity in a conventional way, but the heat that is produced at the same time is not just wasted, but provided to a local area. In fact, the provision of the heat can be primary and the electricity secondary. Such a plant has capacity to vary its output of electricity depending on the heat required and vice versa.

Widespread use of many of such small generation sources (and others) could become more feasible if it could be done in a grid friendly manner. The present invention, in one form, aims to provide a system for aiding the process of inputting energy to a grid.

### SUMMARY

According to a first aspect, there is provided a system for allowing optimisation of use or provision of a resource and/or a service based on an input indicative of the benefit of using and/or providing the resource and/or service at one or more particular future times and/or under one or more particular future operating conditions.

According to a second aspect, there is provided a method of allowing optimisation of use or provision of a resource and/or a service based on an input indicative of the benefit of using and/or providing the resource and/or service at one or more particular future times and/or under one or more particular future operating conditions.

In a preferred embodiment, there is provided an apparatus for controlling operation of the appliance or the device that uses and/or provides the resource or the service, said apparatus comprising means for receiving data indicative of the benefit of operating the appliance or device at one or more particular future times and/or under one or more particular future operating conditions and means for allowing the timing of operation of the appliance to be set based on said data.

In a further preferred form, the apparatus comprises a means for setting the timing of operation of the appliance based on said data. In this preferred embodiment, the means for setting could be a user response to outputted benefit data or the apparatus could determine the most beneficial timing itself.

In one embodiment, the apparatus is for optimising the use or provision of a resource, such as electricity. In this case, the apparatus may be adapted to allow the cheapest or most energy efficient time to operate an appliance, such as a household appliance, which consumes and/or generates electricity. In another embodiment, the apparatus is for optimising the use or provision of a service, such as the use of a road network. In this case, the apparatus may be adapted to allow the cheapest or least busy times to use certain roads to be found based on future congestion information or congestion charges which vary depending on time.

The use of future preferences allows the control apparatus an output of preferred times (more beneficial times) to use (consume) or provide (generate) the resource upon which consumption or provision timing decisions can be based. A setting or display of the timing is an output of the control apparatus. Thus, the present invention allows the consumption or provision to be aligned with the most preferential time to consume or provide. This provides the possibility of optimised consumption or provision.

In a third aspect, there is provided an apparatus for monitoring use (consumption) and/or provision (generation) of a resource and/or a service by a user (consumer) or provider of the resource or service, said apparatus comprising means for receiving data indicative of the benefit of operating the user (consumer) or provider at one or more particular future times and/or under one or more particular future operating conditions; means for monitoring use (consumption) and/or provision (generation) of the resource or service by the user (consumer) or provider; and means for outputting information indicative of a cost of said use (consumption) and/or provision (generation) based on said data.

In a fourth aspect, there is provided a method of monitoring use (consumption) and/or provision (generation) of a resource and/or a service by a user (consumer) or provider of the resource or service, said apparatus comprising receiving data indicative of the benefit of operating the user (consumer) or provider at one or more particular future times and/or under one or more particular future operating conditions; monitoring use (consumption) and/or provision (generation) of the resource or service by the user (consumer) or provider; and outputting information indicative of a cost of said use (consumption) and/or provision (generation) based on said data. The consumer or generator may be an appliance or device as with the first and second aspects.

In one, general, form of the third and fourth aspects, the monitor could provide information concerning the consumption and/or generation for further processing so that the cost can be determined. In a preferred aspect, the monitor itself includes a means for determining the cost of said consumption and/or generation based on said data.

According to the third and fourth aspects, the consumption or generation of a resource by an appliance is enabled to be determined at the appliance, which allows improved planning of consumption or generation and also allows consumption or generation optimisation possibilities to be realised. Further, the costs of generation or consumption can be associated with a particular appliance, which many users will find useful. Thus, a unique crediting/billing system for the resource is possible.

In a preferred embodiment, the monitor outputs an indication of the cost of consumption or generation to a display device. This enables the user to make real time cost based decisions on whether or not it is the right time to consume or generate the resource, which is particularly useful as it can be individualised to the device.

In a further preferred embodiment, the monitor receives further data concerning the present state of a resource distribution network or part of it, preferably indicating the balance between supply and demand on the network or its part, and provides an output indicating a comparison of said consumption and/or generation with the received future time benefit data.

Thus, a preferred embodiment of this aspect provides a flow and cost meter that can compare the actual cost of consumption or generation based on an indication of a state of the network with the cost information that can be derived from the indication of benefit. This comparison is effectively a comparison between predicted costs and real-time costs and thus allows a determination to be made as to whether the network is experiencing unexpected conditions.

A display may be provided to output the comparison, which allows a user to be informed of unexpected resource or network conditions and thus incite a response.

The third and fourth aspects, including the preferred features, may be combined with the first and second aspects in a preferred apparatus or method. The third and fourth aspects, however, offer independent advantages and thus form independent aspects. Further, there follows a series of preferred features, which can be applicable to all aspects.

An example resource would be a utility such as electricity, gas, water, or heat. It may be some constrained resource, such as a road or rail network. In the most preferred embodiment, the resource is electricity.

An example an appliance is one which has some degree of flexibility as to when consumption takes place. Another example appliance is a generator of electricity, which has some degree of flexibility as to when generation takes place.

In a preferred embodiment, the indication of preference (benefit) at future times is transformable to prices of the resource at future times. Thus, price predictions are possible and the estimated future price of consumption or generation can be determined and decisions made as to when to consume or provide can be based thereon within a meaningful context.

In a preferred form, the indications of preference at future times are an indication of prices at future times, which are a representation of balance between supply and demand of the resource on a distribution network, or the benefit (to a user and/or supplier or network) of consuming and/or generating the resource at a particular time. In this case the distribution network is being stabilised as the consumption or provision is being planned based on a representation of supply and demand on that network.

Price is preferably a reflection of the balance between supply and demand for the resource. Such concepts are well established and thus a knowledge base for providing an indication of future preferences already exists. In fact, suppliers of the resource may already model future prices and thus the provision of the indications of preferences at future times may not prove to be overly burdensome in terms of new systems required for implementation.

In a further preferred embodiment, an output is further based upon a user selected deadline for the consumption or provision to take place. Thus, the control apparatus of the present invention balances a desire for optimisation with user requirements. The user may choose not to accept the optimised time to consume and instead request an instantaneous delivery of the service offered by the appliance at the sacrifice of the additional cost. Thus, the user is encouraged to consumer or generate at optimal times, but not forced.

In a preferred embodiment, the control apparatus is adapted to output a consumption or provision control signal to the appliance based on said output of a preferred timing plan. Thus, the control apparatus controls the appliance in accordance with the preferred plan indicated. In a preferred embodiment, the control apparatus is adapted to provide a signal to the appliance to commence execution of the consumption or provision plan.

In one preferred embodiment, the control apparatus includes user input means so that the user can select a plurality of times to consume or provide and the control apparatus is adapted to display a price for each of the times. Thus, the user can be given a series of prices to choose from depending on the consumption or provision time and this will indicate a preferred consumption or provision plan (for example, cheaper price indicates a preferred time).

In the preferred embodiment, the indications of preferences at future times comprises a plurality of numbers representing the preferences, each number associated with a time, the times regularly or irregularly spaced and extending into the future.

The output may provide a plurality of preferable times for commencement of a consumption or provision plan. The preferred control apparatus is adapted to randomly select one commencement time.

The just described preferred feature ensures that when a plurality of preference indications are provided to a population of such systems, synchronised group behaviour is avoided. Such synchronised behaviour by a large number of consumers or generators could destabilise a resource distribution network, e.g. an electricity grid.

In a preferred embodiment, the control apparatus is adapted to access a consumption or provision profile representative of consumption or provision for a given function of the appliance, the profile preferably comprises a plurality of numbers representing a quantity of consumption or provision in performing said function, each number associated with a time, the times regularly or irregularly spaced and extending the duration of the function, wherein the provision of an output indicates a consumption or provision plan for the function and is further based on the consumption or provision profile. In a preferred form, the spacing of the times of the consumption or provision plan and the indications of relative preferences is the same.

A consumption or provision profile for a particular function as well as an indication of future preferences is used to form a preferred plan. Thus, not only is the preference for consumption or provision at future times taken into account, but also the quantity of that consumption or provision for a selected function. Thus, in one embodiment, the future preferences are used in conjunction with expected consumption or generation profiles for a particular function, which can be provided as an alternative to or in addition to the monitoring of the actual consumption or provision by the appliance, as discussed with respect to third and fourth aspects.

In a further preferred embodiment, the control apparatus is adapted to calculate a cost, in terms of preference, for performing a function, the cost being calculated using the consumption or provision profile and the indications of preferences at future times and to output a preferred consumption or provision plan by optimising the cost with respect to time so that a timed consumption or provision plan is outputted. Preferably, the indications of future preferences are transformed to a price so that the cost is outputted as a monetary value. This monetary value can be displayed in a preferred embodiment. The cost could, however, remain as a total preference, which, when displayed, would still enable the user to see a total cost for the action, but it would only be meaningful relative to values for other times for performing the function.

According to the control apparatus of the preferred embodiment then, a predicted future cost can be calculated for performing the function. This is enabled by the use of consumption or provision profiles which detail the quantity of consumption or provision that will take place by performing a function. Further, the breakdown of the preference indications into a plurality of future times and the breakdown of the consumption or provision profile into a plurality of future times means changes in the preference indications will be accurately reflected in the cost prediction and thus provide a valuable optimisation tool.

In a preferred form, the spacing of the times of the consumption or provision plan and the indications of preferences is the same. This eases calculation as the preference indications and consumption quantities are spaced over the same time periods and are thus already in conformity.

In a preferred embodiment, the function can include a plurality of segments having a standard delay time between them, wherein the above stated optimisation alters the delay time between at least two of the segments. Changing delay times can provide optimisation benefits. An example function would be a washing process by a washing machine, where the standard delay time between a wash and dry cycle of the washing process is altered.

In a preferred embodiment, the output indicating a preferred consumption or provision plan is further based upon a deadline for completion of a function and the output is a preferred consumption or provision plan, the cost of which is optimised as above with respect to time, so that a timed consumption or provision plan is outputted, which is timed to be complete by a given deadline.

Where the indication of preference is price, the price for the function has been optimised, thereby providing a cost benefit to the user of the appliance.

The timed consumption or provision plan for a selected function will extend over a period of time according to the duration of the given function.

Thus, according to the control apparatus, the consumption or provision plan produced temporally places the consumption or provision plan in the future and does so in a manner which is optimal with respect to the given relative preferences, which could be predicted price of performing the function.

In a preferred embodiment, the timed consumption or provision plan comprises a plurality of numbers representing a quantity of consumption or provision, each number associated with a time, the times regularly or irregularly spaced in a similar/identical way to the consumption or provision profile, but where the plan has been placed in time as a result of the optimisation. Thus, the effect of the preferred forms is to plan the most optimal time for performing a function based on predicted future prices so that optimal costs are achieved.

In the preferred embodiment, the indications of preferences at future times is provided by a retailer of the resource. The retailer, thus can determine the relative amounts of consumption or provision required at future times and provide the indications of preferences so as to encourage this. Thus, the distributor is able to influence stabilisation of the resource on a distribution network. The retailer is the undertaking selling the resource to the consumer and may also be an undertaking that buys the resource from a provider. In the present UK electricity market, the retailer is known as the supplier.

In a further preferred embodiment, the output indicating a preferred plan is further based upon at least one further indication of preferences of consumption or provision at future times provided by another retailer of the resource and the output of an indication of a preferred consumption or provision comprises a selected one of the retailers. Thus, according to the control apparatus of preferred embodiments, a consumption or provision plan can include a choice of retailer of the resource. This offers the possibility that the retailer offering the most favourable preferences, for example the most favourable price, can be selected. This offers the possibility of competition in the distribution market.

In the preferred embodiment where a plurality of distributors are available, it may be preferable for the control apparatus to include a means to meter the resource in such a way that a plurality of retailers are each attributed to amounts metered for consumption or provision plans in which they were selected. In this way, appropriate billing/crediting to the correct retailer can be effected.

In a preferred embodiment, once the cost of a consumption or provision plan has been calculated, it can be output to a display. In another preferred embodiment, once the timing of the consumption or provision plan has been determined, the control apparatus is adapted to output timing information to the display, in particular, the control apparatus is adapted to determine a completion time of the consumption or provision plan and output the completion time to the display.

In a preferred embodiment, the resource is electricity and the control apparatus includes means to detect a present frequency of the grid and includes a means to interrupt a function taking place or re-plan a consumption or generation plan if the frequency on the electricity grid indicates that such action is preferred. In particular, the control apparatus can transform the frequency to a present price and transform the indications to a predicted price and take the re-determination step or the interrupt step if the present price is sufficiently outside a threshold price. In an alternative preferred embodiment, the control apparatus is adapted to perform said interruption if the frequency of the grid is outside acceptable parameters. This preferred embodiment ensures that any discrepancy between the actual price and that predicted can be reacted to so as to prevent value being lost. Thus, if the price derived from the frequency indicates the predicted price is unacceptably far from the actual price, then a re-planning may be wise to delay to a point where the grid is acting more as expected. It also provides a response to extreme grid conditions where interruption of on-going consumption or generation plans is a saviour. A preferred embodiment which also provides an output indicating stress on a distribution network as discussed above with respect to third and fourth embodiments.

In a preferred embodiment, the control apparatus includes means to receive updates to the indications of preferences at future times. Thus, the preferred embodiments provide functionality to allow the plan to be based on up to date information. According to a preferred embodiment, the updates are provided over the air. According to a further preferred embodiment, the control apparatus is adapted to re-output an indication of a consumption or generation plan not yet being or having been run upon receipt of an update to the indications. Thus, the system not only utilises up to date information, but also reacts to it.

In a most preferred embodiment, which combines the first and second aspects with third and fourth aspects, the indications of preferences at future times are data from which prices for the resource at future times can be derived and the control apparatus comprises means to meter the resource consumed or provided during execution of a consumption or provision plan, where the control apparatus may be adapted to store the prices upon which the consumption or provision plan was based, may be adapted to store the metered quantity and may be adapted to store the consumption or provision plan. This embodiment allows a futures market in trading in the resource to be established. The information stored is suitable for billing/crediting purposes, but with the bill/credit being based on future price indications. Thus, the contract is established in advance and the data stored allows this contract to be met. Futures trading in such a resource has numerous advantages, particularly in improving the stability of the supply and demand of the resource on the distribution network.

In a preferred embodiment, the control apparatus includes transmission means to transfer billing/crediting information to a distributor of the resource.

In another aspect, an appliance is provided which consumes or generates a resource and is responsive to control signals provided by the control apparatus described above.

In another aspect, a system comprises a device or appliance which consumes or generates a resource, a retailer of the resource and a control apparatus as described above.

In a preferred embodiment the distributor of the resource is adapted to provide a first set of indications of preferences at future times. In a preferred embodiment, the retailer does so based on supply and demand considerations of a resource market. Preferably, the distributor includes transmission means to provide the indications in an over the air manner.

In a preferred embodiment of the above system, the system comprises at least one further retailer of the resource wherein the retailer of the resource is adapted to provide a second set of indications of preferences at future times, wherein the control apparatus is adapted to select between the two distributors as described above.

### BRIEF DESCRIPTION OF THE DRAWINGS

FIG. 1 shows an overview of an electricity system which includes apparatus.

FIG. 2 shows an example preference profile.

FIG. 3 shows an example function for transforming preference profile numbers to normalised price.

FIG. 4 shows an example optimisation system including a combined heat and power appliance.

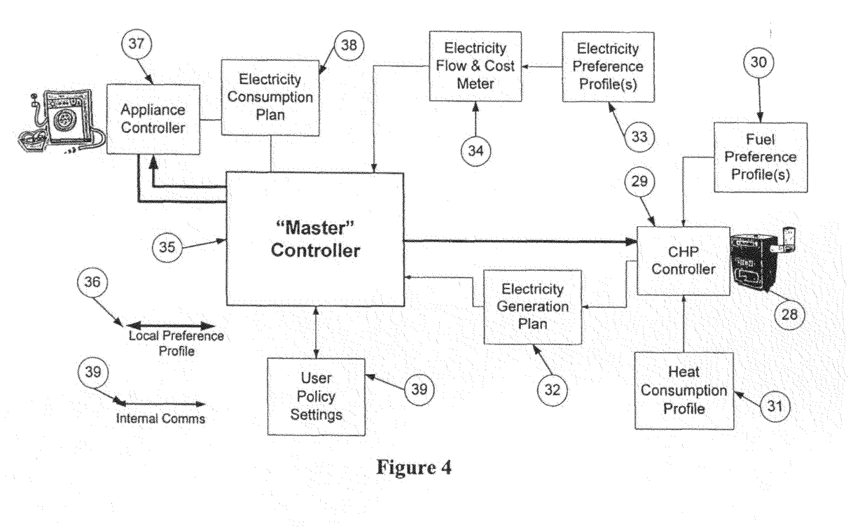

FIG. 5 shows an example consumption profile for an appliance.

FIG. 6 shows a block diagram of preferred features of an apparatus.

FIG. 7 shows a block diagram of the preferred features of a flow and cost meter according to an apparatus.

FIG. 8 shows a block diagram of a preferred displayed output of the apparatus.

FIG. 9 shows the features of an example optimisation support system.

### DETAILED DESCRIPTION

Specific embodiments will now be described by way of example only, with reference to the drawings.

The majority of the detailed description will use electricity as the example resource. However, the present invention also extends to control with other resources and the description provides disclosure of control with such other resources, as already mentioned.

The specific description is mainly concerned with appliances that consume electricity. Appliance which also, or instead, generate a resource may also be controlled.

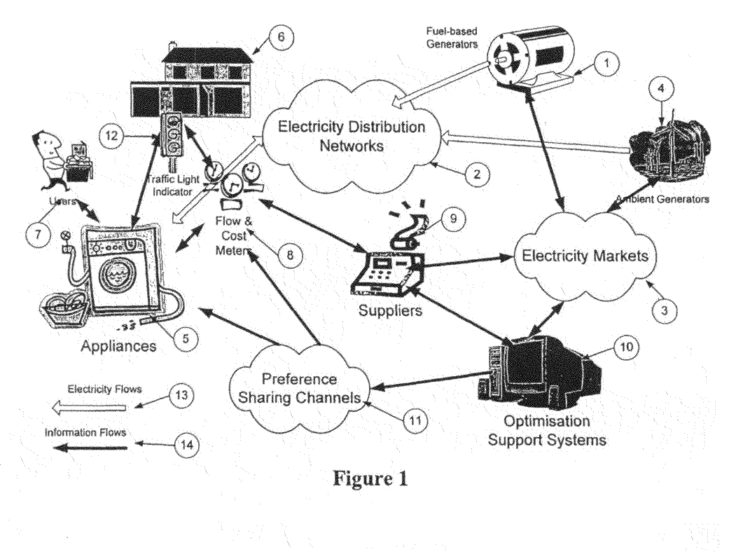

An overview of the control apparatus of the most preferred form is shown in FIG. 1. The control apparatus comprises a series of elements, which are first generally described and the important elements with regard to the present invention are described later in more detail.

The machines and companies that convert fuel into electricity, and deliver electricity to the electricity distribution networks 2 are shown as generators 1. They will decide when and how much to generate according to contracts they achieve in various electricity markets 3. The control apparatus, not shown, aims to enable the generators 1 to operate more efficiently by smoothing the variation in demand with time.

The machines and companies that convert ambient energy, such as wind, wave, sunlight and tidal flows into electricity are shown as ambient generators 4. In general, such generators do not control when generation occurs but will aim to forecast it to support their trading in electricity markets 3 so that they can participate in trading. The ambient generators 4 provide a variability to the supply of electricity which the control apparatus aims to balance by inciting increased consumption at such times.

Appliances 5 are consuming devices that take electricity from the electricity distribution networks 2 and that have some discretion as to when they do so. The timing of the load consumed by such appliances is influenced and takes benefit from the opportunities open to the device to postpone (or bring forward) the bulk of the electricity it needs to consume to provides its service. They are assumed to belong to a household 6, which has to pay a supplier 9 for the electricity used. Advantages arise from controlling the timing of the consumption of the appliance based on predicted future prices such that consumption of electricity on the grid by a system of a population of appliances is smoothed.

A supplier 9 sells electricity to customers, and buys it from generators 1 and 4, thus acting as the electricity retailers and retail market-makers. Their role is to achieve buying contracts that match selling contracts precisely at all times, so that consumption (and some generation) by their customers precisely matches the delivery by their contracting generators. Their current difficulties in doing this, and the risks they face, are a primary driver of the need for the control apparatus.

Users 7 operate appliances and other consuming devices in order that a job is performed, such as loading a washing machine and pressing a start button. More sophisticated user interaction is envisaged and a user 7 may, according to the control apparatus, specify an indication as to how flexible a particular job is in terms of when it may be performed. That is, a user may specify a deadline for completion of a consumption plan. They may be influenced in their consumption by a display 12 indicating when there are good, or less good times to consume. A preferred display is described below and is referred to as a traffic light indicator 12.

A preferred control apparatus includes a flow and cost meter 8. The flow and cost meter 8 measures the flow and cost of electricity to and from the distribution network 2. The flow and cost meter 8 allows measurement of the quantity of electricity consumed by an appliance and also the price quoted for consumption at that time. The flow and cost meter allows trading of the electricity at a future price. It also offers the ability to attribute the consumption of electricity to specific appliances, which can be useful as discussed in more detail below. The flow and cost meter 8 is only a preferred feature and many of the advantages can be achieved in a system using a conventional period meter.

An optimisation support system 10 provides the various mechanisms to enable suppliers to influence their customers, and optimise their role in the system as a whole. In particular, the support system 10 is the collection of information stores and processing subsystems that lead to the formation of a preference profile and its delivery to the control apparatuses.

The preference sharing channels 11 are the various means by which profile setters communicate their preferences to the control apparatuses, and on to households and users. This can vary from permanently fixed factory preset preferences, preferences set at sale time by appliance retailers or authorities to over the air broadcasts. Once deployed, there are various ways and speeds with which the preferences in appliances can be updated.

The description of the preferred embodiments are directed primarily to the UK electricity market. Other electricity markets in other countries may vary or the resource being consumed may not be electricity. While the implementation will vary, the core concepts remain applicable.

Broadly stated, the control apparatus controls the timing of consumption of electricity, or some other resource, by appliances in a manner preferential for both the user and the electricity (or other resource) provision system. The control apparatus realises this benefit by making use of the flexibility of the device as to when a job is performed and delays (or brings forward) the performance of the job. The control apparatus, in the most preferred embodiment, uses the following inputs in deciding when the consumption should take place:

a preference profile to provide a price indicator for a number of times, including future times. It is also a preferred feature of the invention that the control apparatus includes means for receiving updates to a preference profile controlling timing of a consumption plan to be performed based on the updated profile. A re-determination of the time for carrying out a consumption plan may also be desirable in light of the updated profile. The preference profile is the means by which a profile setter communicates their time of consumption preferences to a population of control apparatuses. The preference profile is preferably a transformation of a future price in the preferred embodiment;

a random element to randomise to some extent when, of the desirable low price times, the consumption begins. The random element ensures that the collective consumption of a large number of appliances is spread evenly across a period of time, so long as there are no cost disadvantages to the user (or the profile setter) for so doing. It enables a random selection from among the feasible low cost load start times;

a consumption profile associated with a consumption plan to be performed by the appliance. The consumption profile at least provides an indication of the period to completion of a job and also an indication of the quantity of electricity consumption throughout the progression of the job;

user selected variables offer the user some control over the consumption timing of their appliances. An example would be the selection of a deadline for consumption plan completion, beyond which is an unacceptable delay for performing the consumption plan, despite a lower price.

Each of these inputs to the control apparatus and their use to optimally time the consumption of a resource by an appliance will now be described in further detail.

A preference profile is preferably a profile of a price indicator as it varies with time. The profile includes prices extending into the future and these are predicted values. The control apparatus of the preferred embodiment receives the preference profile by a communication from a profile setter. Various techniques are available to minimise the communication necessary. A basic technique is a price profile for a standard time cycle, such as a day, week or year, which was set in the factory and then extrapolated indefinitely.

The preference profile is related to the future price of electricity by a reversible function that is derived from its anticipated future price, and that may be converted back into a future price or used directly by the control apparatus. This conversion function will need parameters, some of which will be communicated with the preference profile. Alternatively, the appliance can use the profile more directly to make simple plans for future consumption.

The preference profile is visible to and used by the control apparatus of the appliances in order to plan their operation at minimum cost. The future price is set by suppliers 9 and/or other market makers in anticipation of the future behaviour of the electricity system, and in the light of the various contracts and commitments they have made. In an economic sense it can be considered a key set of parameters for a contract offered by a market maker to a market player.

The preference profile, while a reversible transformation of a predicted future price for the resource, can be used as the price source for billing purposes. Thus, a user can purchase the price of consumption for an appliance at a price settled in advance of the consumption. This is a development from the well understood market concept of a futures market price, used by physical players to hedge the risks of volatility in the spot market. Alternatively, the preference profile may be used for deciding on the timing of the consumption, but the real-time price used for billing. The flow cost meter 8, discussed below, enables both of these options.

In its presently preferred implementation, a preference profile is a series of numbers each associated with a specific time, and that extend into the future. The number represents a relative preference (of a market maker or supplier) for consumption to take place in relation to the times before and after the specific time. That is, if the number (indicator of preference) for one time is greater than a number for an earlier time, then the relative preference is to consume during the later time.

To give an example of the numbers of the preference profile, a range of between 0 and 2 can be adopted. In the range from 0 to 1, the transformation of the number into a price leads to a price to be paid by a consumer for the consumption. In the range from 1 to 2, the transformation is into a price paid to the consumer for the consumption. This latter situation will rarely arise.

More rigorously, the number represents the relative preference for the infinitesimal time dt, which in a practical implementation will become the finite time Δt, where the time Δt is small in relation to the speed with which circumstances (and so prices) change. In electricity, a period of a second looks to be as small as could be useful and using this as an example, the preference profile would include an indicator of predicted price for each second.

In practice, the period that is most relevant and useful may be much bigger than the more theoretical Δt just given. Many players will, for example, be use to the wholesale settlement period, such as the UK's half hour. So, in practice, the preference profile may be expressed as a discrete value, which is an indicator of price, for each period. This period is known as a “Trading Period”. A Trading Period could include a discrete (and potentially large) number of Δt periods.

A preference profile will usually include an element of periodicity and cycling repeats. For electricity, the most common cycle is a day, extending to a week, a season, and a year.

It may be useful in some implementations to be able to create future preference profiles from a default one. For this purpose, the present invention envisages an elementary preference profile, which is a preference profile covering a defined period, for example a day, and in principle consisting of the series of numbers associated with times defined above. A particular elementary preference profile may be given a reference name.

An elementary preference profile can be combined with one or more others in order to create a composite preference profile. This combination can be performed, possibly by the control apparatus, by preference profile operators. A composite preference profile may also be given a reference name.

Example preference profile operators are:
Repeat (n, elementary preference profile). Copy an elementary preference profile n times to extend it into the future. A character, e.g. 0, could be used to signify an indefinite repeat.
Extend (elementary preference profile 1, elementary preference profile 2). This operator causes elementary preference profile 1 to be followed by elementary preference profile 2.

Two further operators are possible, but need to be used with care, as the relationship between the preference profile numbers and the price they represent (see below) may not be linear. Thus, an alternative to using the following operators on preference profile numbers may be to perform the operation on the price after transformation and then transform the result back to a price.

Add (elementary preference profile 1, elementary preference profile 2). This operation arithmetically adds the two elementary preference profiles, so giving a further one.

Invert (elementary preference profile). This operator arithmetically inverts an elementary preference profile, so as to permit one to be subtracted from another.

Corresponding operators for composite preference profiles are applicable.

The operators permit compact communication of preference profiles. For example, an elementary preference profile could be remotely communicated to the control apparatus or provided at the factory. Thus, an elementary preference profile labelled “Normal Working Day”, and one named “Normal Weekend Day”, a composite preference profile named “Normal Working Week” can be expressed as:
Normal Working Week=Extend (Repeat (5, Normal Working Day), Repeat (2, Normal Weekend Day))
   As another example, a “Simple Standard Day” elementary preference profile could be defined and extended into the indefinite future by

PP=Repeat (0,“Standard Day”)

There is the possibility of large step changes in the numbers at the boundaries of trading periods. Such step changes can encourage synchronised behaviour from those using the preference profile to make decisions as to when they consume (or produce). Such synchronised behaviour is an undesirable artefact of the design of the trading arrangements and creates risks for the stability of the electricity system. Much of this risk can be avoided by “softening” the boundaries between trading periods. A smoothing function can be used so that discrete values associated with a trading period are converted into more gently varying values associated with each Δt.

Different smoothing functions may be appropriate in different circumstances, and many will require some parameters to optimise their effect. Example parameters will identify: trading period, the Δt, the smoothing algorithm; and the parameters associated with it. Suitable algorithms include interpolation, polynomial, Bezier or Spline, which are known in the art.

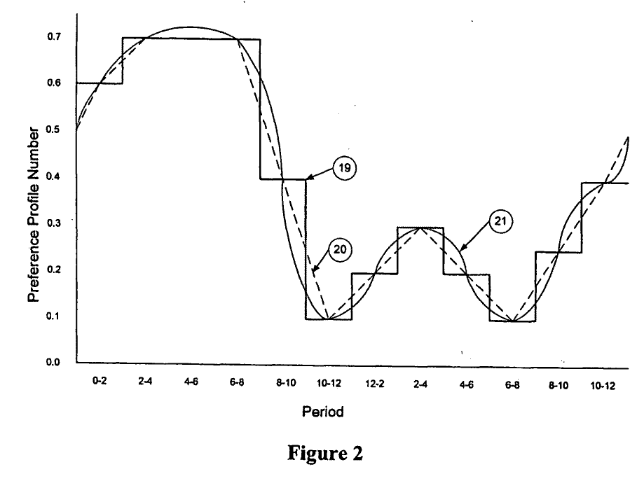

An example preference profile is shown in FIG. 2. Profile numbers 19, representing a price of the resource, are given for a number of discrete time periods through a cyclic period of consumption of the resource. The smoothing 20, 21 of the preference profile is also shown.

In one embodiment, the preference profile numbers have no absolute meaning. Like various market indexes (such as the FT 100) it is meaningful only in a relative sense.

The preference profile numbers are most useful if, on average, they are about 50% (0.5) as this gives maximum flexibility and scope to cope with future uncertainties. There may be political or commercial reasons to allow comparisons of different preference profiles, so it may be constrained to ensure its average over a period (or periods) falls within a defined band. The periods over which this is measured may vary from days (the average preference for a day over other days), through weeks (the average preference for a particular week over other weeks), over seasons (the average preference for a season over other seasons) or years (the average preference of one year over another).

While it is convenient to express the preference profile as concerning consumption, the concept may extend to negative consumption, i.e. production/provision. In this case, a smaller preference profile number implies a preference to produce at that time over others, and a larger preference profile number implies a preference not to produce.

The preference profile is generated within the optimisation support system, which is discussed below, of the supplier or another participating market-maker. In a preferred embodiment, the preference profile reflects a commitment to offer the price reflected in the number. In this way, a futures market is established and consumption may be purchased in advance. In such a situation, the preference profile setter is a player in the market who is willing to speculate as to the future state of the market, and so offer a price (including a premium) to those who wish to hedge their risks when making future commitments. They will take into account their own trading positions in various electricity markets, as well as knowledge of their customers, and, in some cases, operation of physical assets such as generators. In an alternative embodiment, the preference profile is more reflective of the expected behaviour of price of consumption in the future, but without a commitment to offer that price.

In many countries, the preference profile setter will be a supplier 9. However, it may also be an authority or state agency exercising influence over the behaviour of consumers and their devices. The “Profile Setter” may, however, be doing the setting on behalf of others.

The preference profile is preferably updatable at any time by the supplier 9, but there may be constraints in communicating the update to appliances. In the embodiment where the supplier is contracted to the prices indicated by the preference profile, if the communication of an update fails, the supplier is assumed to remain committed to any contract implied by the preference profile that was available to the control apparatus before the communication failure.

The preference profile can be transformed in various as listed below. Each of these transformations is discussed in greater detail below.

To a general preference index.

To a normalised expected future price.

To a normalised sell price and/or a normalised buy price.

To contract prices in currency.

To benchmark prices indexes.

Each of these transformations will need one or more parameters, so a preference profile will be associated with a parameter set. The parameter set can, like the preference profile, itself be updated at any time.

A general preference index (GPI) is an index that is suitable for a user to quickly recognise whether consumption at the present time is preferable. Many users may be more comfortable with an indication of when it is best to consume load. This transformation converts the personal preference numbers to numbers that are considered more useful from a user perspective.

The most straightforward transformation is a linear transformation of the personal profile numbers to a different range. The most straightforward transformation is a linear transformation:

GPI=aGPI+bCPI*PPN

However, more sophisticated transformations, using polynomial, logarithmic or, trigonometric functions may prove more helpful or attractive.

The normalised expected future price (NEFP) can (in principle) be derived from the preference profile numbers by any reversible mathematical function with the appropriate characteristics. The choice of function depends upon circumstances and upon empirical experience, and different suppliers (or countries or regions or grids) may choose to adopt different transformation methods. The broad principle is that the expected future price chosen by the profile setter is transformed into a personal preference number (so in the range 0 to 2), and it can be transformed back into an expected future price by the inverse of the function.

The example transformation of the present description transforms a higher value between 0 and 1 into a higher price for the consumer to pay and a higher value between 1 and 2 transforms to a higher priced to be paid to the consumer. A number in this range also implies that a householder has to pay to generate, a circumstance that can arise if ambient generation sources are particularly plentiful (such as a sunny and windy spring afternoon.) At 1, the price is zero.

Example transformation functions that may be suitable include a linear transformation. That is, a transformation of the form

NEFP=aNEFP+(preference profile number−1)*bNEFP, where bNEFP<0

This has the disadvantage that maximum (and minimum) prices cannot exceed thresholds defined by the value of bNEPN. A more suitable transformation function is a tangential one, such as

NEFP=bNEPF*tan((preference profile number−1)/(π/2)) where bNEPF<0

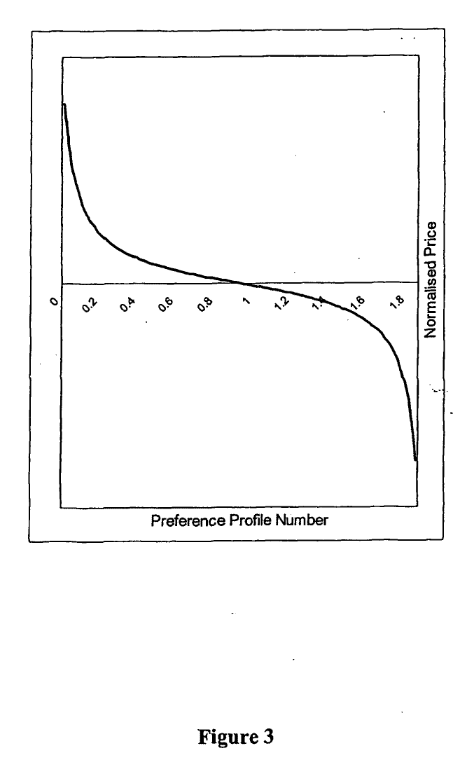

This has the advantage that as the preference profile number approaches its limits the price becomes rapidly larger (potentially infinite), as can be seen from FIG. 3. At the mid range of the function, the normalised expected future price is zero, and, with a preference profile number of about 0.5, the relationship is most closely linear.

A transformation from a preference profile to a normalised buy price (NBP) or a normalised sell price (NSP) can also be performed. The normalised sell price is envisaged to be the most commonly used by the control mechanism of the present invention. It is also envisaged, however, that appliances controlled by the present invention will have some capacity for generation. In this case, the appropriate time to supply the generation would be indicated by a high normalised buy price. The normalised expected future price can be further transformed in order to provide the normalised buy price or the normalised sell price, depending upon whether the appliance or device being controlled consumes or produces.

It may also be possible to provide two preference profiles, a consumption preference profile for consuming appliances and a generation preference profile for appliances with some capacity for generation. Generation preference profiles are discussed in more detail below. The provision of two separate profiles allows the normalised buy price and the normalised sell price to be provided as two separate and notionally independent sets of numbers, and the spread is implicit in the differences between the two. The normalised expected future price would become a price indicator (or index), derived from a function of the normalised buy price and the normalised sell price, which would become the actual basis for planning. It may, however, be preferable for the spread to be derived from transformations of a single normalised expected future price.

The transformation from a normalised expected future price is achieved by incrementing (for consuming appliances) or decrementing (for producing appliances) the normalised expected future price, using functions and parameters communicated as associated with the preference profile. In this way, a spread is achieved so that the supplier profits. Several functions (or some mixture of them) can be used to perform the transformation. Example functions are given below.

Proportionate. That is, the spread is proportionate to the price.

NBP=NEFP*(1+aNBP), where aNBP will usually be around 1-10%;

or

NSP=NEFP*(1−aNSP), where aNSP will again usually be around 1-10%

Constant. That is, the spread is a fixed parameter aNBP and aNSP, giving functions:

NBP=NEFP*(1+aNBP), or

NSP=NEFP*(1+aNSP)

Time related. It is reasonable for the spread to increase as the uncertainties of the future increase, thereby reflecting the increased risk being taken. A spread related to an hour ahead would be smaller than the spread related to a day or a week ahead.

This last, time related function can also play a useful role in protecting participants and the system against communications failures that prevent or disable updating of the profile. Extrapolation forward with a growing spread gives the best available forward planning information, taking into account the uncertainties. If this is updated at a later time, then uncertainty is reduced, and the spread can reduce. If, on the other hand, communications failure prevents it being updated, there is still a “reasonable” basis on which to plan and actually consume, and this will be reflected in the cost charged.

A contract price in currency may also be derived. The normalised buy price and the normalised sell price can be converted into currency, and may then be used as the basis for a contract price (CP) for the control apparatus and the profile setter. This is a further proportionate transformation of the normalised sell price or normalised buy price, and is expressed in the relevant currency. An example transformation for this is:

CP=bcurrency*NSP, or

CP=bcurrency*NBP.

The parameters for conversion of normalised buy price or normalised sell price into currency can become critical contractual parameters, changes to which directly impact the bills for the consumption. As such, they are subject to controls, which may be subject to regulatory oversight, before they can be changed.

The preferred forms also envisage certain other preference profiles.

A generation preference profile, as briefly mentioned above, can also be supplied to a generating device to indicate relative preference for the device to supply the resource to the distribution network, e.g. electricity. Some appliances may be generators, or, like batteries, both consume and produce electricity. A generation preference profile supports participation in the electricity markets, although this is open only to reasonably large players.

Optimisation of the electricity system is complicated by supply of generation to a distribution network as this could make it more difficult to predict the balance between supply and demand on the grid. However, suppliers can anticipate the small scale generation, and so factor their output into their own preference profiles. The generation would then be paid for partly by displacing overall consumption, and partly also by the spread of the current price for exports from the distribution network against the current price for imports.

Another example of the use of preference profiles occurs for a system of appliances being served by a combined heat and power plant, the local generation, and also the distribution network, the external generation. A combined heat and power plant uses reject heat from an electricity generation plant to heat buildings in a surrounding area through a district energy system.

In the case of a Combined Heat and Power plant, one approach is for the combined heat and power appliance 28 to develop a plan based on an optimisation of the other utility provided—in this case heat (or steam). An initial plan would be made by the combined heat and power plant control apparatus using a fuel preference profile 30 and a heat consumption profile 31 to optimise heat demand and would treat the electricity production as secondary. From this plan, a generation plan 32 would also arise, and would include indications of the costs of feasible incremental changes to the plan.

A “Master” controller for electricity 35, can convert this into a local preference profile 36 for electricity by “adding” it to a supplier preference profile 33. In this case, the electricity preference profile is received via the electricity flow and cost meter 34. The conversion into prices would be according to the user policy settings 36. This local preference profile can be passed to other appliance controllers 37 in the same local system. This local preference profile 36 then becomes an initial basis for optimising the consuming appliance.

Once one (or more) local appliance controllers have developed a consumption plan 38 based on the local preference profile, this can, in turn, be passed back to the “Master” controller, along with total anticipated cost and an indication of the change in costs associated with changes in starting time (e.g. 1 minute earlier costs an extra x normalised units). This in turn will develop a revised local preference profile 36 and share this with the local appliances and the combined hear and power controller. Thus a dialogue is established whereby the master appliance can compare the costs of incremental change by one appliance with incremental change associated with other appliances and the combined heat and power appliance. If a cheaper overall plan is revealed the local preference profile 36 is adjusted and the participating appliances can “hill climb” towards an improved optimisation.

The “Master” controller may readily be implemented within any of the individual controllers or within the flow and cost meter 34, and so in a simple case, there may be only two participating devices. Generation can be considered as negative consumption, and included in the optimisation in this way.

It can be seen from the above discussion that it is advantageous, and in some preferred embodiments, necessary, for the control apparatuses to be capable of communicating between themselves, passing relevant profiles and re-optimising in the light of enhanced knowledge of local circumstances.

Another modification of the general form of preference profile is a local preference profile for different areas on an electricity supply system.

Limits in the capacities of transmission (and sometimes distribution) systems prevent them transporting all available electricity from the cheapest sources to where it is needed—the system is constrained. These constraints are complex and not easily precisely predictable. This complicates the scheduling and despatch of electricity that optimum markets would often come up with. Often, a transmission and system operator will need to intervene in the market and/or adjust the scheduling so as to avoid configurations in which the constraints push the system towards instability or higher risk. Such matters significantly complicate the achievement of overall efficiency in electricity markets.

One way of dealing with this is to have a location dependent market price adjustment. For example, if the price of electricity is higher in areas where constraints prevent the import of the all cheapest available electricity, then market will tend to encourage generation within those areas, or, in conjunction with the present control apparatus, discourage consumption in those areas.

This can be achieved by having different preference profiles for different areas, or by having some form of preference profile sub-channel by which the price adjustments in different areas are shared. It may be that, in such circumstances, the preference profile sub-channel is driven by a different player than the supplier, such as a transmission and system operator, who can share information about a premium or a discount over the sub-channel.

The capacity to make local adjustments through the preference profile can also play a role in maintaining the balance of flows across networks close to real time, and enhance the power and flexibility of “Automatic Generator Control” systems, as discussed below.

In interconnected grids the whole system operates to a single system frequency, with many parties across the entire interconnect contributing to keeping the frequency stable. As a consequence, when an imbalance arises in any one part of the grid (known as a control area), say from the failure of a generator, all other parts (or control areas) of the grid contribute to compensating for the imbalance, and the electricity flows into the control area that is short. The flows will differ from expected or scheduled flows, and it is the responsibility of the short control area to do something about these increased flows.

The conventional way to handle this is to calculate an “area control error”, derived at a control centre from available information about the total flows. So if the area control error indicates a shortage in the area, then area control calculates how to deal with it, using available information about the generators in its area, and their costs, and changes the settings of the generators participating in the automatic generator control apparatus for the area. These schemes provide a slow control loop, so that the system as a whole compensates within a few minutes of errors arising.

The control of the preferred embodiments, enable an area control centre, when it detects an imbalance, to update a preference profile, or a preference profile sub-channel, to increment or decrement the price (or just preference) in its area, and thus provoke a change in generation (or consumption).

Participation in compensating for the imbalance can be widened, and, by using a market pricing mechanism, the efficiency of the changes is optimal.

This approach of having localised preference profiles or prices is also applicable to road pricing, where a local profile may cover a single road, a route, or a zone, and may be managed by a road control centre. A journey plan will then consider the costs of using the roads for a journey at the time when its transit is expected.

Another form of preference profile, a social preference profile, is envisaged to have use in the control apparatus. For some users, exemplified by the elderly or infirm and their carers, the priority is to ensure adequate warmth rather than optimum cost. Their need for warmth in their homes varies significantly with the weather, and this is recognised in some social security schemes by releasing extra funds to pay for extra heating during cold spells.

However, this is a rather blunt instrument, operating retrospectively, and may still require the users to take action to control or adjust their space heating. It may therefore be useful for agencies other than suppliers, such a social security services, to have ways of influencing the space heating or other energy uses of significant numbers of users, and to do so independent of cost.

The social preference profile is a way to do this. Like the local pricing, this may be a wholly separate profile or it can be a sub-channel of the preference profile. It may be a preference updated daily and may, have a local element to reflect the relative chilliness of different parts of the country. For appliances the social preference profile will be an additional input taken into account in optimising the timing of loads, such as space heaters. In order to achieve such a social preference profile, consumption may need to be attributable to the space heater so that the cost of the space heating can be apportioned to the social security service.

Influencing the consumption of appliances and device by fine price control leaves open the possibility that a large number of appliances will reach the same decisions as to their optimum start time. It is best for the electricity system, however, that the load be spread over a period of equal preference.

In situations where a control apparatus for an appliance determines a range of possible consumption times where the cost is at its minimum, the electricity system can benefit if a population of devices spread their consumption over the period or periods of equal preference. The control apparatus of the appliance, in a preferred implementation, thus makes each feasible minimum cost start time equally likely and uses a random source to choose the actual start time from the population of possible start times. It is neither beneficial nor unbeneficial to the individual user whether the control apparatus chooses one time or another.

The preferred implementation of the control apparatus also makes use of appliance consumption profiles. Consumption profiles describe the expected pattern of consumption over time. In particular, the consumption profile is associated with a particular job carried out by a particular appliance. Calculations with a consumption profile and a preference profile, rather than just using a preference profile, will give a more accurate reflection of the total costs. Optimisation with respect to this cost is a preferred feature of the invention. Furthermore, the combination of a consumption profile and a preference profile allows the costs of consuming to perform a job to be accurately predicted in advance, which can be beneficial.

An elementary consumption profile is a series of numbers that each concern a time relative to the start time of the elementary consumption profile. The number represents the expected consumption at that relative time, with a larger number representing more consumption. The consumption may be negative (i.e. production).

An example range for the consumption is between −1 and +1, with 0 representing no consumption and no production. These consumption profiles may be considered as normalised. An elementary consumption profile can be associated with a scaling parameter in order to convert it to a physical measure of the actual consumption.

A consumption profile number represents the consumption during an infinitesimal time dt. In implementation, the period it represents will be a finite time, and will be chosen to match the Δt of the preference profiles. The Δt will need to be sufficiently small that consumption changes that fall within, rather than at the boundary of Δts, do not significantly effect the total cost.

Specific elementary consumption profiles may be named, in a similar way as discussed for the labelling of certain preference profiles.

Consumption profiles may be made up of a series of one or more elementary consumption profiles. For example, in the case of a washing machine, a spin cycle may be a first elementary consumption profile and a drying cycle the second. This example is discussed further below. The boundaries between the elementary consumption profiles define that minimum and maximum acceptable delay that can arise between the elementary consumption profiles. The delay could be expressed as a number of Δts. Other parameters may be useful in defining the delay between elementary consumption profiles. For example, it may be useful to have a manual confirmation or have a timing constraint related to the chosen deadline before starting a drying cycle, as this can prevent clothes being left creased for an extended period.

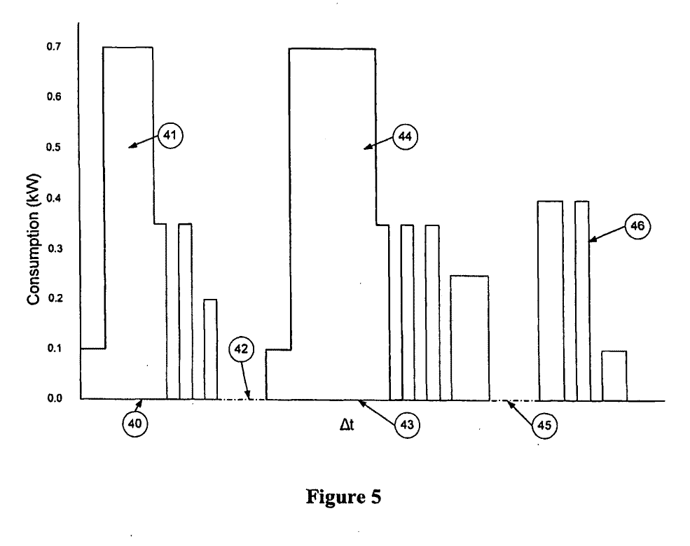

The electrical consumption of a washing machine programme will be described with reference to FIG. 5. The programme can consist of elementary consumption profiles associated with a pre-wash 40, with a high consumption heating period 41, a main wash 43, again with a high consumption heating period 44 a rinse and drying process 46. Clearly, these processes take place in sequence, and some delay between the main cycles, for example the gap periods 42 and 45 could be altered, may be of no significance to the process. Changing the delay may offer opportunities to reduce the overall consumption cost. An appliance consumption profile can be constructed in this way, and the possibility of delay is taken into consideration in the optimisation.

In the case of appliances and consuming devices, the determination of when to consume is achieved by comparing the resulting cost for all feasible times at which to start the consuming profile of the appliance. This optimisation will lead to one or a range of times with minimum cost, and the consumption starting time is chosen as the one time or from the number of times as described above.

Associated with an elementary consumption profile may be an indicator of willingness to be interrupted. This may be used during execution of the plan based on the profile to postpone the consumption to avoid high price periods in the “spot” market. This may, however, be less relevant if the price of consumption has been purchased in advance.

An alternative form of elementary consumption profile is a total consumption profile, which may be useful in some circumstances. This is where the total consumption is defined, but there is flexibility as to how quickly it is taken. Thus, defining the consumption in a manner fixed with respect to time is less relevant. For example, in charging a battery (say overnight for a car) the electricity necessary to top it up fully is known, but, within limits, it does not matter whether this is in a short, high consumption rate period, or a longer, lower consumption rate period. It is also possible that losses will vary according to the speed of charge, but that such losses could be compensated by making best use of cheaper rates.

Sometimes a consumption profile will not be known with precision in advance. For example, the electricity needed to bring wash or rinse water up to a desired temperature depends upon input water temperature and other factors. In this case the elementary consumption profile will need to include parameters to indicate the expected consumption, and the feasible variation from this.

Households and users also have a consumption profile, a household consumption profile, which has a more complex but cyclical pattern extending further into the future. In this case household consumption profiles can be compared with various past preference profiles or preference profiles with future prices to yield a comparison of costs for that profile among various preference profile offerings. Thus chosen household preference profiles can be processed into price benchmarks by which suppliers can be compared. The comparison can be used to allow market information providers and or regulators to minimise the gaming opportunities open to suppliers. The household consumption profile concept may be extended to include industrial and commercial consumption.

For households (or indeed many other sites or units of consumption), longer timescales are most relevant, and there is, as with preference profiles, a strong repeating aspect. For household consumption profiles, periodicity features similar to those of preference profiles are included. Specifically,

A household consumption profile (HCP) may consist of one or more elementary consumption profiles and/or household consumption profiles, which are combined by use of consumption profile operators to produce the household consumption profile. A household consumption profile (as well as an elementary consumption profile) may be given a reference name.

Household consumption operators generate a new household consumption profile from one or two household consumption profiles to form a new household consumption profile. The operators are:
Repeat (n, HCP). Copy a household consumption profile n times to extend it into the future.
Extend (HCP1, HCP2). Household consumption profile 1 is followed immediately by household consumption profile 2
Add (HCP1, HCP2). Arithmetically add the two household consumption profiles, so giving a further household consumption profile
Invert (HCP). This arithmetically inverts a household consumption profile, so as to permit a household consumption profile to be subtracted from another.

Note that, unlike preference profiles, there is no non-linearity to damage these arithmetic operations.

The operators permits compact definitions and communication of preference profiles. Examples given with respect to the preference profile operators are applicable with respect to the operators being discussed here.

Also possible are comparisons of the normalised costs when a household consumption profile is compared with normalised preference profiles offered by one supplier at different times. Thus it will be possible to detect whether a supplier is “gaming” the preference profile in order to inflate costs without changing their published “contract cost” parameters. A regulators (and market information providers) thus have ways of monitoring the preference profile behaviour of suppliers, and report where there are behaviours that cause a suspicion of gaming.

Some appliances may be generators, capable of converting fuel into electricity, and with at least some control over when they generate. In addition, a storage device can choose to consume (filling its store), or produce (emptying its store). One method by which such appliances can participate in optimisation is for them to be represented by a negative consumption profile. Larger scale generators may wish to participate in the Electricity Markets on their own account and these can also make use of a negative consumption profile.

It has been discussed above that a consumption profile can be combined with a preference profile from a supplier in order to accurately determine the costs associated with running the consumption profile. It is envisaged that the control apparatus allows the presence of a plurality of suppliers and the consumption profile along with the control apparatus can also be used in determining which supplier should be selected.

Control apparatuses may have sight of a range of preference profiles from different suppliers and can use these to choose from among them when planning their consumption. The combination of the lowest cost of supplier and consumption time is chosen. This will involve iteratively processing through the various preference profiles and the different start times within the preference profiles to find the lowest total cost for performing the consumption cycle.

In order to allow a series of suppliers to be used, a flow and cost meter, which is discussed in detail below, would have to be able to measure and account for the consumption associated with different suppliers. There is the possibility that the supplier will game by late adjustments to their preference profile. This can be addressed by an embodiment, as mentioned above, where appliances are allowed to “contract” a future price, to which the supplier becomes committed. There may need to be further rules to ensure that the market “clears”, and that there is no possibility of consumption that is not attributable to a supplier.

Another alternative in the case of multiple suppliers would be for a decision to be made to choose a particular supplier for a longer period. This may be taken by using a household consumption profile with the various preference profiles being offered by different suppliers to choose a lowest cost supplier. Alternatively a series of appliance consumption profiles can be combined with a preference profile being offered by a supplier to get a guide on likely costs and compare suppliers.

A customer may then commit to a specific supplier for a period ahead, such as in the UK for 28 days ahead. The customer thus relies on the honesty and fairness of the preference profile offered by the supplier, and so will wish for some contractual promise about the total cost implied by their consumption pattern over a longer period. Such an assurance can be provided by costing one or more standard consumption profiles against the actual preference profile of the supplier. The cost of consumption according to the main benchmark profile would be determined. If this cost increased, the supplier would be suspected of increasing prices. There could be a variety of benchmark profiles determined.

Such a benchmark does not adequately reflect the value gained by adjusting the household profile to better suit a preference profile, so some further standard measures would be helpful. This can be implemented by on-going adjustment of the benchmark profile, (just as with the “urban driving cycle”) or by some more dynamic analysis of preference profiles. It is beyond the scope of this technical specification.

The possibility of negative consumption, i.e. generation, and the associate profiles will now be discussed.

Large scale fuel based generation is likely to continue to play a role in electricity markets for some time, and it is useful to suppliers to be able to enter into medium and long term contracts. The portfolio of such contracts will be a major input to their setting of the preference profile. These contracts may be negotiated bilaterally, or via market exchanges.

In each case, it can be useful to have some standardised contracts, reflecting, as closely as possible the needs of buyers and the capability of sellers. In electricity, one useful form of contract can be a “Generation Profile”.

A generation profile is a consumption profile, but with negative consumption. It is a defined pattern of generation over time. Unlike a consumption profile, however, a generation contract is more useful, and trading would be more liquid, if its starting time is constrained. It would thus cover (say) a week, starting at some defined (arbitrary) time, or a month, or a four week period, or a day.

It would be useful to define several standard generation profile “shapes”, such as baseload, mid-merit, short term, which can take into account the main characteristics of generators, such as ramping up, ramping down, minimum stable generation. Some of these generation profile shapes could well correspond to standard consumption profiles, and so could, in principle, be designated as “Wicks”.

So a contract could be for mid merit type 3 January 2007, or a peak type 6 week 43 2008. Or a peakhour type 10 for 15.00 25th Jan. 2007, or a baseload (500MW) 2009.

The various standard “Wicks” would need to be designed so that a portfolio of various Wicks with various starting times can be used to construct any feasible collection of “Household Consumption Profiles”.

There are various possibilities for the pre-purchasing of consumption contracts by a supplier. It can be useful for actual consumption on a site to include electricity sourced from more than one contract. Examples of multiple contracts follow.

Electricity consumption of a PC, or TV may be purchased as part of the purchase price of the device, with the manufacturer accepting liability for the standby electricity consumed, and, for the consumption during a chosen period of active use. An appliance may choose to fix a contract, based on the profile, with a supplier, but buy other electricity from other suppliers. Social care or government programmes may choose to fund a level and profile of consumption that they deem necessary to achieve acceptable levels of warmth. It may be also that a social care programme will feel it appropriate to fund a space heater or a space heating programme rather than provide the funds to do so. A flow and cost meter able to attribute costs to the storage heater will allow the necessary accounting of the aid given. This consumption may be influenced further by input from the social preference profile, discussed above.

On larger sites, it may be possible to buy “base load” at a lower cost, and top it up at a higher price from other sources. When this is so, it is useful if this can be reflected in the metering arrangements, so that the meter allocates portions of the total consumption to different contracts. Tariffs can include fixed elements and more variable elements.

A “Contract Consumption Profile” is envisaged by in order to implement the example consumption contracts given above. The contract consumption profile defines the consumption profile over a period and is associated with a fixed price for consumption against the profile. Various conditions of the contract can define further arrangements for allocation of actual consumption. So some tariffs may not, for example, give any credit for consumption below the profile, or to rank the order of allocation of consumption to contracts. It would be possible, for example, for a social services department to fund the portion of consumption that is taken by space heating, as defined by a contract profile, but not the portion used for other purposes.

In order that the control apparatus does not adversely affect the service being offered by the appliance, some degree of user participation in the control is envisaged.

The user of an appliance, at the time they wish to use it, is in the best position to make sensible decisions about the urgency and so timing of the consumption of their appliance, as well as deciding other policies about consumption and its cost. Much of the value of the control apparatus lies in giving users (and not just the utility company) a participatory choice, while still providing the benefit of a more optimal consumption distribution.

A key choice presented to a user is the completion time for a task they have set up and wish the appliance to deliver. While this might quite often be “as soon as possible”, this is a choice that has cost consequences, either for the utility company, or for the user, of for both. The extra cost may provide no added benefit to the user.

There can be too much user participation if the use of the control apparatus becomes overly complex. Thus, an excess of decisions to make or too much information being provided should be avoided.

A preferred approach to providing user interaction will be described. When the user indicates that the appliance is ready to go, and has, for example, chosen the wash programme, the controller adopts a set of defaults that look sensible in the context of all that it knows. For example, if set up on the evening, it will assume that completion is required by the next morning, and will show the cost for completion as late as possible (usually just before the price increments of the start of the working day occur). If the controller has been set to a fixed time (such as 5 o'clock am), this will be implemented. (It may not need to be shown, as the user can be assumed to be aware of the setting).

When the user has a choice, the default deadline and the cost implications of this default are shown. So it may be 5.30 am and 0.50 p.

The user can then change the default deadline (by turning a knob for example), making it sooner, or making it later. In general, making it sooner will increase the cost. Making it later may not, as the optimum time may not be moved forward. For example, a shift of deadline from 5.00 am until 7.00 am may make later consumption feasible, but it is no more attractive, as later consumption may cost more. An attempt to relax the deadline by turning the knob may move the deadline a long way forward—perhaps into a weekend. The controller will suggest the next deadline that is likely to be lower cost. The cost implications of the new deadline are shown, and the user can then commit, (a go button).

The process can be simplified further by having an urgent button. “Do it now.” Again, the cost implications could be shown.

Once the deadline has been set, the appliance should perform its tasks by the required time, unless overridden by other policies.

One relatively simple and quick way to reach an initial suggested deadline is to scan the preference profile for all times beyond the earliest feasible completion time. Any point where the normalised price starts to increase is a candidate deadline, as any delay past this point is likely to increase the cost of consumption. “Draft” plans for each of these deadlines can then be developed and priced (using the consumption profile for the task to be performed), and one of them chosen in the light of household policies already set.

There are a number of other policy related parameters that the user may be offered the opportunity to set or change, and that will influence the timing of consumption. Actual parameters will depend upon the implementation. A series of examples can be given for possible useful areas of user participation.

A maximum price can be set by the user. As the electricity price is dynamic there is the possibility that the price will rise significantly during execution of the plan, so making it more expensive to maintain the deadline. By setting a lower maximum price, the appliance will be less willing to continue when prices rise. Setting a higher maximum price will give a higher priority to meeting the deadline.

A willingness to delay can be set. A willingness to delay may allow greater use of short term price dips or avoid short term price spikes. It may allow the appliance to make a greater contribution to grid stability, for example, by providing response to grid conditions during part of its cycle. Willingness to delay may be reflected in some sort of tariff benefit, and so have cost implications.

Preference for “fixed price” against variable price. The user can choose to purchase the consumption in advance, but with a premium reflecting the risk taken by the supplier in agreeing this future price. Alternatively, the user can choose to accept a variable real time price, but the risks of any fluctuation from that predicted, i.e. increase, are borne by the user.

A user may choose to set a default completion time. Some users may have preferences for, for example, very early morning completions.

A user could also decide to choose a particular supplier, if this is not set by another mechanism.

An important preferred embodiment is the ability to dynamically update the preference profiles. This allows future prices to be more accurately predicted as a future time becomes closer and thus provides greater scope for users to rely on the prices given. Utility optimisation arises largely from planning the consumption using the best available information at the time of the plan. In some cases, the plan will be fixed and final, and barring major contingencies, will be executed as planned. If the control apparatus has communication with a flow and cost meter with the relevant features, the controller can also “fix” the price of the execution in advance. Thus, it can be seen that predictions as up to date as possible are important.

Circumstances can change, a power station might break down for example, and the information on which the plan is based, such as a wind forecast, can become firmer and better as “now” approaches. The user may also find that circumstances have changed and wish to bring forward the deadline. Up to date information is very important to this, both in terms of updating preference profiles and updating user requirements.

Updating preference profiles relies on the capacities and nature of the profile sharing channels. In principle, this can be done at any time, and, so long as the “fixed price” option has not been invoked, gives an opportunity to re-plan and optimise in the light of the latest information. Most commonly the preference profile updates will reference periods ahead of the chosen deadline, and there is no benefit in changing the consumption plan.

If the updated preference profile changes the prices during the duration of the plan, then these changed prices will trigger a re-planning. The re-planning will initially assume the same deadline, but may find that there is a significant benefit in a relaxing of the deadline. If this is so, the user policy parameters will be used to make choices between higher cost and slipped deadline.

Again, if a previous plan has started execution, there may be further constraints in the options open to a new plan, and these will be taken into account.

There are good reasons for a supplier to update their preference profiles, such as a change in the wind or wave forecast, and less good reasons for updating, such as gaming by changing increasing prices to increase income after customers have become committed to a plan, and so have reduced flexibility to respond to increased prices.

In part the risk of gaming can be mitigated by the ability to “fix” a price at consumption plan commitment time, but there will likely need to be some oversight of profiles and their changes, to ensure that players with market power are not abusing their capacity to change prices.

Of course, fixing the delivery price at plan commitment time also reduces the flexibility to respond to changing circumstances, such as loss of a generating plant, or stronger winds than forecast. One useful tool to help manage this is to distinguish between late profile changes and a physical instantaneous changes in demand or supply on the electricity. These latter changes can be distinguished by measuring the frequency of the electricity supplied to the control apparatus. Frequency on a grid provides a reflection of the instantaneous balance between supply and demand and so can not be deceived.

It is also an important preferred feature that the control apparatus be responsive to users changing their plan. At any time before, or even during execution of the plan, the user may choose to set an alternative deadline and have the device re-plan. Clearly, the options are more constrained as some start times are no longer available, and if it is a single batch process, there may be no sensible option but to complete the execution of the plan. However, if it is a multi-batch process, there may be options for bringing forward the plan, and if the deadline is relaxed, there may be options for lowering the cost. The control apparatus will take into account any previously committed and now irrevocable consumption.

The control apparatus of the present invention plans based on forecast prices. However, all futures eventually become “now” when there is a “spot” price. This spot price may change rapidly, and it is helpful if this can trigger changes to plans, such as delays to or avoidance of consumption.

Parameters by which a spot price can be defined from the behaviour of the frequency on the electricity grid may be included as part of the preference profile, and so are available to the controller. Normally, the spot price will have been fairly accurately predicted by the preference profile, so changing execution as a result of the spot price will be unusual.

In the case of a consuming device, an event of significance will be an increase in the spot price, and the optimum response to this is to delay execution, and so avoid consumption during the high price period, at least if this can be done without harm to the appliance or its service. To enable this, the consumption profile may include parameters indicating the sensitivity of the demand to interruption. A heating cycle will, within limits, be interruptible, but a spin cycle (say) will not be.

There are various known ways of optimising parameters. Some method of optimisation is required by the control apparatus of the present invention in order to minimise costs based on the preference profile, probabilistic inputs, and the consumption profile and also user requirements and perhaps various other parameters. Outline methods, by way of example, for optimisation will be discussed below.

Optimisation involves planning and executing activities in such as way as to minimise cost (or some resource), but without violating constraints. There is a rich literature about optimisation, optimisation approaches, and optimisation methods among many disciplines.

In summary, an example of the preferred inputs to the optimisation method are the appliance consumption profile, which is a pattern of consumption over a defined period, the preference profile, including the relevant prices over a period ahead, and the deadline by which the consumption must be complete. At planning time, there is an earliest feasible start time, and a latest feasible start time.

The algorithm below shows one way of performing the optimisation with basic appliance consumption profiles. More sophisticated appliance consumption profiles, with, for example, the possibility of variation in total consumption, will increase the complexity, but the core approach will remain similar.

### Simple Minimum Cost Plan

Reset overall minimum cost marker, latest minimum cost start time marker and early minimum cost time marker.

For each Δt increment between earliest feasible start time and latest feasible start time:
Reset the start time cost accumulator
For each Δt increment through the appliance consumption profile
Calculate the cost of consumption during the increment using the preference profile number for the corresponding Δt of the appliance consumption profile
Increment the start time cost accumulator
Repeat until last Δt increment of the appliance consumption profile
If the current start time cost accumulator is lower than previous
Note minimum cost markers, and latest minimum cost start time
If the current start time cost accumulator is the same as at present
Note new early minimum cost start time
Repeat until last feasible start time.
Plan using minimum cost markers and the minimum cost time.

If the consumption profile includes several separate processes, such as pre-wash, wash, rinse and dry, with the possibility of delays between the batches, the optimisation may be more complex, but enables full benefit to be gained from multiple peaks and toughs in the preference profile. There are choices about the sequence with which batches are planned. Here we an example algorithm that works backwards, from the last batch, is given.

Multiple Batch First Pass Minimum Cost Plan
Set unplanned deadline to offered deadline
For each unplanned batch in consumption profile
Calculate (from the CP) the earliest feasible start time of last unplanned batch.
Calculate (from the unplanned deadline) the latest feasible start time of last unplanned batch.
Use above algorithm to plan the batch.
Mark planned start time and cost of the batch, and remove from unplanned batch list
Repeat until batches all marked as planned.
Record this plan as “First Pass Plan”

If the preference profile is complex, with multiple peaks, it is possible that the plan derived in this way will be less than optimal (for example, the plan for a lower consumption last batch might prevent a higher cost earlier batch from moving into a cheaper period.). This possibility can be minimised by choosing the sequence in which each batch is planned according to its total consumption, so planning high consumption batches first. The calculation of earliest feasible start time and latest feasible start time of each batch is slightly more complex, but the approach remains the same.

There remains the possibility that the plan is still not optimal. One further alternative for an improved optimum can be found by “hill climbing”.
Hill Climbing
Reset Total Cost increment accumulator.
For each batch in First Pass Plan
Reset each batch increment accumulator.
Calculate the cost change from “bringing forward” the batch start time by an increment (if this is feasible).
Calculate the cost change increment for all other batches caused by this timing change (using the above Multiple Batch First Pass Cost Plan).
If cost is lower adopt revised plan
Repeat with further “brought forward” increment
Calculate the cost change from “delaying” the batch start time by an increment (if this is feasible)
Calculate the cost change increment for all other batches caused by this timing change (using the Multiple Batch First Pass Cost Plan)
If cost is lower adopt revised plan
Repeat with further “brought forward” increment
Repeat for next batch

It may be that the above algorithms produce a range of possible start times at a minimum cost. In such a case, a method to distribute starting times of a population of loads discovering corresponding start times is desirable. As discussed above, one such method is to set each possible start time having an equal probability and choose the actual start time at random from these. Across a population of devices with similar needs, this process distributes the consumption as evenly as possible.

A random number can be chosen for each batch, and the same random number is preferably re-applied in any subsequent re-planning. Re-drawing a random number each time introduces unpredictability into the optimisation planning process, and this may not have any additional value.

In order to further remove the probability of a population of consumption appliances from starting at the same time, the scale of possible start times can be transformed. Thus, where the preference profile numbers are relatively high the period is “stretched” and where the preference profile is relatively low, it is compressed. A random selection, giving equal probability to each point on this transformed scale, can then be used to choose a particular start time. This transformation can take into account the consumption profile so that “end effects” (the change in preference profile towards the deadline and from the earliest feasible time) are taken into account.

Some households (and other) appliances participate in more than one utility market. For example, a combined heat and power system may consume gas as a fuel, and create heat and electricity as outputs to household(s). The timing of gas consumption could contribute to optimisation of the gas system (although for domestic purposes, this will not usually be significant). The electricity may be used within the household, or may be exported, so the timing of this can contribute to overall optimisation, and the heat may contribute to the household, either as space heating or to heat hot water (which, unlike electricity, can be stored). If the household is connected to a heat distribution system it may also be able to import or export heat, and the heat system can be optimised by changes to the timing of any import and export.

In short, optimisation is multi-faceted complex problem, depending as it does on a host of factors, many variable and not all of which are influenced by the behaviour of the appliance or set of appliances.

As discussed previously, optimising across multiple appliances in a household (or other collection) depends upon the formation of a preference profile for each utility within each household, and communication of preference profiles and consumption profiles between appliances. Here an optimisation approach is considered when a single appliance participates in two or more utility markets. Thus, the optimisation takes place within the control apparatus, but the results of the optimisation of each utility may be shared with other appliances.

In general, the “leadership” of each utility market can be ranked. A combined heat and power system, for example, is generally regarded as being “heat led”. That is, the appliance will first optimise to meet the need for heat, and only secondarily will optimise for electricity. If there is any gas optimisation, that will come last.

The optimisation approach starts from an assumption of ranked leadership, and this may vary according to the market circumstances. In most cases it is clear, and will lead to a near optimal plan. If there is the possibility of the plan being significantly non optimal, then an alternative plan can be formed using a different ranking, and the plan with the lowest overall cost adopted.

An example algorithm would be as follows.
Multi-Utility First Pass Minimum Cost Plan
For each utility participating, in ranked order
Develop an appliance consumption profile for this utility. If this is the highest ranking utility, this will often be drawn from the appliance consumption profile database for that utility. In other cases, it will be derived from the higher ranking optimisation
Develop a First Pass Minimum cost plan. (do not randomise yet!)
Use this plan to construct a new appliance consumption profile for the next level utility
Repeat for each Utility

This produces a priced plan, optimised for the lead utility, and, within the constraints of higher ranking utilities, feasible for all utilities. This plan can then be flexed, so that plans with feasible variations in the timing of the lead utility batches are used to build and cost optimised plans for the other utilities. Any variation that produces a lower overall cost outcome is then enlarged until no further cost reduction is achieved.

If there are many feasible plans with equally low costs, the selection between them can be made at random, albeit from a more complex set of possibilities.

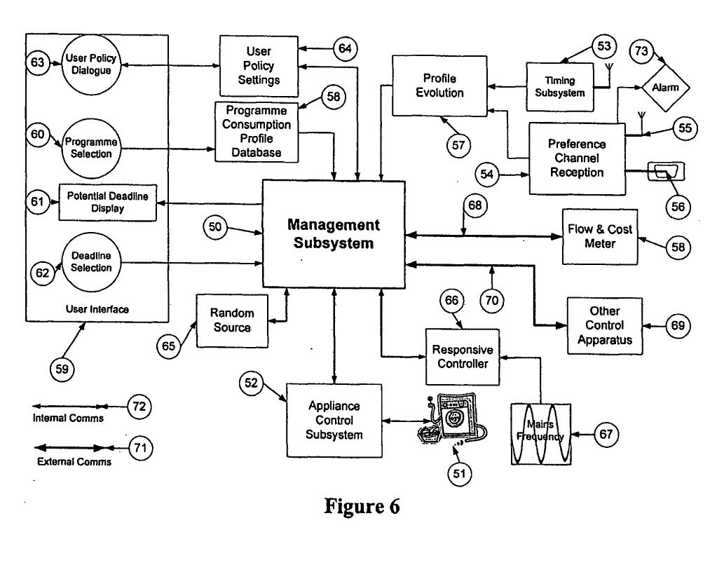

The control apparatus itself is shown in FIG. 6. The control apparatus, in a preferred embodiment, provides an output to an appliance to execute the optimised timing plan.

Central to the controller is the management subsystem 50 which processes the information received from other subsystems, performs the algorithms, and passes information out to other subsystems. In the diagram, communications internal to the controller are shown 72 and distinguished from the communications to external devices 71. The management subsystem can most effectively be implemented within a programmable microcomputer, but its functions could be performed by a set of individual controllers.

An important output is control of the appliance 51. The detailed control is exercised through an appliance control subsystem 52, which is designed for the specifics of the appliance.

The controller has access to the calendar time and the day of week. The timing subsystem 53 maintains the relevant time and makes it available to the controller. While it is possible to have the clock set in the factory, and subsequently maintained, it is also possible to use external broadcast sources, by which the time can be localised and its accuracy maintained.

The controller utilises a preference profile, as described earlier, which can be received from any channel for which this is used. This is the task of the preference profile channel reception subsystem 54. The reception method may be some sort of electrical interface 56 such as a USB port or smart card reader, by which profile parameters are received. The reception may arise in the factory, at the retailer, or may be after the appliance has been delivered. The profile, which is shared with many other devices, may also be received off air 55 from a broadcast, such as on the data channel carried as part of the UK long wave radio.

Whatever the reception method, the preference profile channel reception subsystem 54 will include cryptographic protection so that only receptions from pre-authorised sources are used in the control. Cryptographic protection is known in the art.

In case reception fails for a significant time, the control apparatus may be fitted with an audible or visible alarm 73, to give an indication to the user that the preference profile is no longer being updated.

The preference profile includes significant periodicity, with repeats and variations over time. The preference profile does, however, extend into the future, and it is the task of the profile evolution subsystem 57 to carry out any necessary repetition and extrapolation, and provide the management system 50 with one (or more) preference profiles for the period of relevance for planning.

A controller including these timing and profile subsystems is able to make and execute optimised plans and deliver the system benefits. The owner of the appliance can gain further benefit, if the consumption is measured by a flow and cost meter 58. The flow and cost meter 58 itself includes the timing and profile subsystems. Indeed, the meter may well be owned and or controlled by a supplier, and it will be the supplier that sets the preference profile. This raises the possibility that the controller and the flow and cost meter will not hold precisely the same preference profiles. A possible consequence of this is that the plan thought to be optimal by the controller incurs costs different from those expected, and the possibility of dispute arises.

This possibility can be avoided if the control apparatus receives all its timing and preference profile information from the flow and cost meter itself, via a (possibly external) communications channel 68. If such a channel is available, the controller will no longer need to include or use the subsystems to receive this information 53 to 57.

In some preferred embodiments, the control apparatus will choose from among several possible competing suppliers, each communicating their preference profile. If this is the case multiple preference channel reception subsystems 54 may be included. Alternatively, the flow and cost meter may provide the several preference profiles.

In some embodiments, the control apparatus will be optimising across two or more utilities, so will be receiving preference profiles and related parameters concerning (say) electricity, gas and heat. When this is the case, it may include two or more separate preference channel reception subsystems 54. Alternatively, the communication is with the flow and cost meters 58 for the relevant utilities.

Some appliances can vary the service they deliver according to a programme, selected from a range of programmes built in to the appliance. Each programme will have an associated appliance consumption profile, and the relevant appliance consumption profile can be retrieved from the programme consumption profile database 58 (and will also include relevant instructions to drive the appliance control subsystem 52).

The user, via the user interface 59 will first select the programme for the service they wish, using a programme selection device 60. This may be a turnable knob, and may be associated with a display showing the programme selected.

Once the programme is known, the management subsystem will use the chosen consumption profile, the known preference profile, and any available policy settings to calculate a possible deadline and the expected associated cost. This suggested deadline and expected cost may be displayed on the potential deadline display 61.

The user may then choose to adjust the deadline using the deadline selection device 62. Again, this can conveniently be a turnable knob, giving options to delay or bring forward the deadline. The choice may be confirmed by a specific action, such as pressing the knob, or come into effect after an appropriate timeout. At this point no further user input is required until the programme has completed, although the user may choose to come back later and adjust the deadline.

Depending upon the implementation, there are other user settings that can be adjusted. When this is so, the user policy settings subsystem 64 will operate and react to the user policy dialogue controls 63.

Once the user has provided all the information needed, the management subsystem 50 will, in one envisaged implementation, perform the following steps:
Refine the plan, using the optimisation approaches described previously.
If appropriate, choose from among possible suppliers for the most cost effective preference profile for this task.
Where randomisation is used, the random source 65 will be used to draw a random number.
If appropriate, share the plan with other control apparatus, and undertake any necessary re-planning in the light of the dialogue (discussed further below).
If appropriate, undertake any further optimisation to incorporate the preference profiles of other utilities used by the appliance into the plan.
If appropriate, communicate the plan, in the form of a contract consumption profile, to the flow and cost meter that measures the consumption of the appliance (discussed further below).
Monitor the time, waiting until the next time for starting a consumption profile run.
Monitor any changes to the preference profile that are received, and, when necessary, re-planning.
Instructing the appliance control subsystem 52 when start times are reached.
Monitoring the responsive controller subsystem 66 (see below) for significant changes in the state of the overall system and for changes in prices.

The responsive controller 66 is an implementation of the inventions disclosed UK Patent No. GB 2407927 entitled Responsive Substation and UK Patent Application No. GB 00511361.8 entitled Responsive Load Controller. The responsive controller 66 monitors the mains frequency 67, and, in conjunction with parameters associated with the preference profile performs two main functions. If the appliance is in a load consuming mode that can be (or has been) interrupted, such as heating water, it decides whether to interrupt the consumption in order to assist the overall stability of the electricity network. Further, it derives a view of the spot price of electricity and whether this has departed significantly from the expected price (as revealed by the preference profile). If so, this price information is offered to the management subsystem 50, which may then use it to re-plan and modify the execution of any existing plan.

The control apparatus may, in some preferred embodiments, have communications with two external devices, a flow and cost meter 58, via communications channel 68, and other control apparatus', via a communications channel 70.

Communication with the flow and cost meter is for two main purposes. One, which is an optional feature, is for the flow and cost meter to provide the control apparatus with a preference profile and associated parameters, thus ensuring the optimisation planning is based on the same information as is used to measure the consumption. A second is for the control apparatus to commit to a contract consumption pattern at a cost based on the latest available profile, so that the flow and cost meter can account for this consumption at the agreed price. This is discussed in greater detail below.

The appliance being controlled by a control apparatus may be only one of several appliances within the household or site. For example, there may be a dishwasher, a laundry machine, a combined heat and power boiler and a hot water tank. Optimising them together requires that they communicate their plans, and adjust each others plans in the light of the available information.

A good way to achieve combined optimisation is to use a private preference profile to reach a market oriented optimum. One way would be to nominate one of the control apparatuses as “Master”, and enable it to derive a new private and local preference profile that is then shared with other appliances. Each control apparatus for each appliance shares their consumption profiles with the Master, which then modifies the private preference profile to take them into account, and shares the updated preference profile with participating appliances. Initially, the private preference profile would be derived directly from a supplier's preference profile.

In summary, preference profiles, consumption profiles and timing data are shared over channels 68 and 70.

There are numerous possible implementations of the communications means used with the control of the present invention. Several possibilities are considered suitable.

Local Area Network technologies, such as ethernet or wi-fi may be suitable. These offer more capacity and speed than is needed, but may, in some households, be the most cost effective. Bluetooth is another possibility. Again, it may be higher capacity than is necessary, but is becoming cheap and ubiquitous. Zigbee is another possibility. Zigbee offers a lower power, lower capacity communications service, which may become common within many electronic devices. A power line carrier could be implemented, by which a signal is impressed on the main and carried a short distance to the other appliances. Finally, mobile phone and SMS technologies could be taken advantage of.

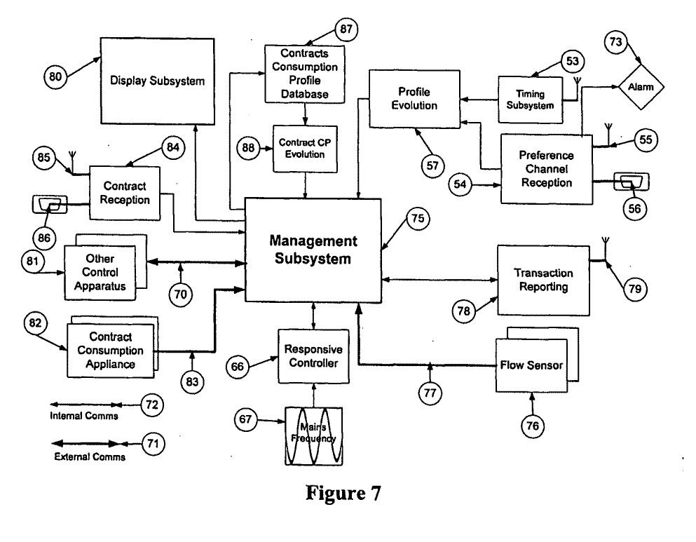

The flow and cost meter 58 has been mentioned previously and offers an important preferred embodiment. A flow and cost meter 58 opens the possibility for trading a resource, such as electricity in advance of its consumption. This allows certainty for the user and potentially offers a more stable balance between supply and demand of the resource throughout the day. This, in turn, will improve efficiency of generation and provision of the resource. Other advantages are realised there besides. FIG. 7 shows a preferred embodiment of the flow and cost meter 58 and the features will be described below.

The meter includes a management subsystem 75, which processes the information received from other subsystems, performs the algorithms, and passes information out to other subsystems. In the diagram, communications internal to the controller are shown 72 and distinguished from the communications to external devices 71. The management subsystem can effectively be implemented within a programmable microcomputer, but its functions could be performed by a set of individual controllers.

A key input to the flow and cost meter 58 is information from flow sensors 76. These are signals indicating the flow of the consumed product(s). The preferred signal provides a stream of measurements of consumption over a period Δt, but in implementation, it may be convenient to sample the flow rate so that an integration of a fixed number of sample periods gives the consumption over the period Δt.

Any suitable communications medium can be used, but the idea would be one (or more) communications medium that is standardised across the measurement industry. Because there is a constant stream of significant information it is likely to be a different medium than for the other external communications, and it is, for example, less suited to radio.

Generally, flow and cost meters will be connected to only one sensor (e.g. electricity), but implementations to include multiple sensors (such as gas, electricity and heat) are possible.

An important output from the flow and cost meter is a report of total cost, and, if necessary, reports of consumption and consumption transactions. The reports are prepared by the transaction reporting subsystem 78, which then manages their transmissions over a communications channel 79 to the supplier. Any suitable communication method may be used.

An alternative method of reporting is via the flow and cost meter display subsystem 80. The relevant details are made available by the management subsystem 75, and displayed in a form that is useful for a supplier to capture the data. The display may also provide information to the household. One form of display can be a “traffic light” signal to the consumer, and this is further described below.

The display subsystem 80 may also be used to allow users to access consumption and other contract information held within the meter.

The flow and cost meter needs to know the calendar time and the day of week (like reference numbers are used as with the control apparatus, but they are not necessarily the same physical component). The timing subsystem 53 maintains the relevant time and makes it available to the flow and cost meter 58. While it is possible to have the clock set in the factory, and subsequently maintained, it is also possible to use external broadcast sources, by which the time can be localised and its accuracy maintained.

The flow and cost meter utilises a preference profile, as described earlier. A preference channel reception subsystem 54 is able to receive the preference profile. The reception method may be some sort of electrical interface 56, such as a USB port or smart card reader, by which profile parameters are received, but this will clearly limit the flexibility and so usefulness of the meter.

Preferably, the flow and cost meter receives updated preference profiles to reflect the expected future state of the electricity market over the next hours, days or weeks. Preferably, the reception is performed by means of some form of reception from a broadcast communications channel, so that many devices can receive the same information simultaneously (and fairly quickly). A low bit rate channel, such as that carried on the Long Wave of the UK's Radio 4 is well suited. Other similar channels may be carried by FM radio (and so more localised), or on a range of broadcast services. Thus, the flow and cost meter should be fitted where reception is reasonable or with an appropriate antenna system. In case reception fails for a significant time, the flow and cost meter may be fitted with an audible or visible alarm 73 to give an indication to the user that the preference profile is no longer being updated.

An alternative to the above communications means is two way communications systems, such as the internet, or mobile SMS, or specialist proprietary systems (such as Power Line Carrier). The preference profile is preferably received fairly regularly (more than once per day) and fairly reliably so that the flow and cost meter is able to provide the benefit of accurate costs estimates to give reasonable basis for future electricity purchasing.

The preference channel reception should include cryptographic protection so that only receptions from pre-authorised sources are used in the control.

The preference profile includes significant periodicity, with repeats and variations over time. The preference profile does, however, extend into the future, and it is the task of the profile evolution subsystem 57 to carry out any necessary repetition and extrapolation, and provide the management system 75 with one (or more) preference profiles for the period of relevance for planning.

The flow and cost meter 58 can usefully exchange information with other appliances. If these appliances include a control apparatus 81, the communications channel 70 will enable the preference profile(s) received and held in the flow and cost meter to be passed to the control apparatus(s). Thus, the preference profiles used by the control apparatuses for optimisation are synchronised with those used to calculate the charges, and also means the appliance does not need such sophisticated preference profile reception capability.

The communications channel 70 will also enable the control apparatuses to commit to a fixed price for the planned consumption, so that, even if there are late changes in spot prices, the user can be assured the appliance will complete on time. A consumption profile is transferred to the flow and cost meter and marked as a contract, thereby providing functionality to purchase the consumption in advance.

Consumption of other appliances may also fall within the flow associated with the meter 58. Some appliances may have been sold with a portion of their consumption pre-paid, and therefore “to the account of” the appliance manufacturer or retailer. Each contract consumption appliance 82 may communicate the details of their contract to the flow and cost meter, which will then separately account for the pre-paid consumption.

The communication means 83 to the flow and cost meter may be whatever is convenient and available. Two example possibilities are particularly attractive: Zigbee, which is low power and short distance, but well capable of carrying the necessary low volume of data; and power line carrier, which may be useful to assure that the appliance is truly associated with the measured electricity flow.

In some cases the flow may have been purchased under multiple contracts. For example, it may be that a social care agency will pay a space heating element of the consumption. The actual consumption for a particular contract may be influenced by a social preference profile. In such circumstances the contract reception subsystem 84 will be used to ensure the flow and cost meter has the necessary contract information. In a similar way to the preference channel reception 54, the contract can be passed via a separate communications channel 85, or via a USB port of a Smart Card reader 86. As with other external communications, cryptographic protection is used to ensure the proper authorisation of the contract.

The flow and cost meter 58 will hold details of the various contracts in its contract consumption profile database 87. Some may be long term (weeks or months) and others shorter term (a single run of an appliance). In each case the consumption profile data is used by the contract consumption profile evolution subsystem 88 to evolve the consumption profiles to reflect the present contract flow, and provide this to the management subsystem 75.

The operation of the flow and cost meter 58, managed and executed by the management subsystem 75 will be described. The following steps are for each Δt,
The preference profile(s) is (are) evolved to give the preference profile numbers for the current time, and the current default buy and sell price(s) are calculated.

The responsive controller 66, discussed above, uses parameters passed to it that are associated with the main current preference profile by monitoring the mains frequency 67, derives price adjustments based on the real time circumstances of the grid.

The flows from the flow sensors 76 are received or calculated from finer samples to give the total over the Δt.

The expected flows from the various active contracts are deducted from the total flow, taking into account the parameters associated with each contract.

The residual flow is multiplied by the relevant adjusted buy or sell price, to give a cost associated with the Δt period.

The cost is added to (or subtracted from) the account of the supplier responsible.

The flow may be added to an accumulator of the total flow, so as to provide a cross check with more traditional meter measures.

From time to time, the accumulated account for each supplier is passed back via the transaction reporting subsystem 78, and the record in the flow and cost meter may be reset.

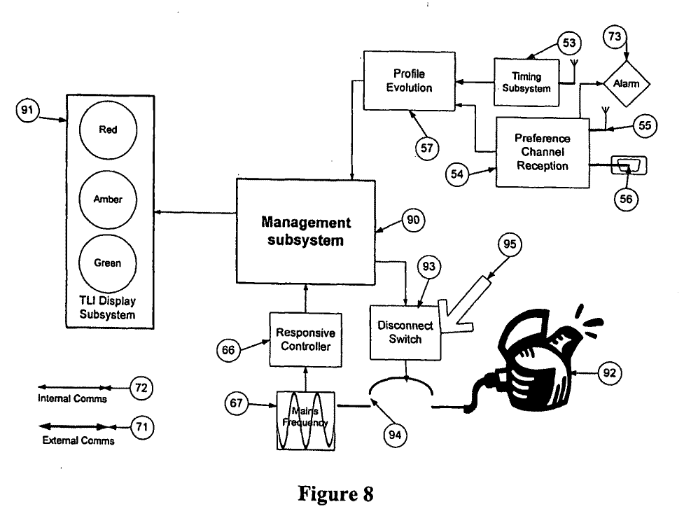

It may in some instances with some consuming devices be preferable for a person to make a decision as to whether a delay in consumption is tolerable. Such decisions are can be aided if the user knows whether there is any benefit in delay, either in terms of reduced cost, or to the electricity system as a whole. A traffic light indicator fulfilling this purpose in an especially beneficial manner will now be described with reference to FIG. 8.

The traffic light indicator includes a management subsystem 90 which processes the information received from other subsystems, performs the algorithms, and passes information out to the display subsystems. In the diagram, communications internal to the controller 72 are shown and distinguished from communications external 71 to devices. The management subsystem 90 can most effectively be implemented within a programmable microcomputer, but its functions could be performed by a set of individual controllers.

The responsive controller 66 has been discussed above.

The responsive controller monitors the mains frequency 67 and derives a stress status of the system, as indicated by the mains frequency. The status may be normal, when there is no evidence that the system is under particular stress. The status may be stressed, which indicates that the system has moved beyond normal parameters and there are indications that extra load is unhelpful to the overall stability of the grid. Finally, the grid could be determined to be in a crisis condition, which indicates that the grid has moved to a state where extra consumption enhances the risk of system failure, and reduction in consumption reduces the risks to the system.

The responsive controller 66 needs some parameters in order to derive reasonable assessments of the grid state. Some can be derived from long term analysis of the past behaviour of the grid, as described in UK Patent Application No. GB 00511361.8 entitled Responsive Load Controller. If there is access to a preference profile, it could include the parameters which may be updated from time to time. If there is no access to a preference profile, then the parameters will be factory preset.

The responsive controller 66 may also derive a view of the spot price of electricity and whether this has departed significantly from the expected price (as revealed by the preference profile). The price will vary while the system frequency is operating within normal parameters, as well as if the system is stressed or in crisis (when the price adjustment is likely to be significant).

The traffic light indicator receives the above information from the responsive controller and outputs a convenient indicator for guiding the user.

The traffic light indicator should have means for determining the calendar time and the day of week. The timing subsystem 53 maintains the relevant time and makes it available to the traffic light indicator. While it is possible to have the clock set in the factory, and subsequently maintained, it is also possible to use external broadcast sources, by which the time can be localised and its accuracy maintained.

The traffic light indicator should have means for receiving a preference profile, as described earlier, and so needs to be able to receive from any channels for which this is used. This means is provided by the preference channel reception subsystem 54. The reception method may be some sort of electrical interface 56 such as a USB port or smart card reader, by which profile parameters are received, but this will clearly limit the flexibility and so usefulness of the indicator.

The traffic light indicator should have functionality for determining an expected current price from a received preference profile and optionally to also have means to determine a future price trend (only if the price is falling is there benefit in delaying).

The most convenient method to receive the preference profile is some form of reception from a broadcast communications channel, so that many devices can receive the same information simultaneously (and fairly quickly). A low bit rate channel, such as that carried on the Long Wave of the UK's Radio 4 is well suited. Other similar channels may be carried by FM radio (and so more localised), or on a range of broadcast services. The traffic light indicator should, therefore, be fitted where reception is reasonable. In case reception fails for a significant time, the traffic light indicator may be fitted with an audible or visible alarm 73 to give indication to the user that the preference profile is no longer being updated.

The preference channel reception 54 should include cryptographic protection so that only receptions from pre-authorised sources are used.

The preference profile includes significant periodicity, with repeats and variations over time. The preference profile does, however, extend into the future, and it is the task of the profile evolution subsystem 5 to carry out any necessary repetition and extrapolation, and provide the management system 90 with one (or more) preference profiles for the period of relevance for planning.

The traffic light indicator monitor may have the capacity to disconnect load 92. When used, the disconnect switch 93 will detect the crisis circumstances as determined by the responsive load controller 66, which is a situation where a disconnection is likely to be useful. When detection takes place, the disconnect switch 93 will trigger a circuit breaker 94 that will disconnect the load. To ensure that users can decide that their crisis is greater than that of the grid, there is an override button 95, which a user can press that will reconnect the circuit breaker, and will prevent further disconnection for a period. If used with an electric kettle, for example, the period would be the time necessary to boil a reasonably full kettle.

In preferred operation, the traffic light indicator receives two key inputs. The first is the stress state of the grid as determined by the responsive controller 66. From this input, the traffic light indicator can determine which of its outputs to display. The traffic light indicator has three main outputs, a red light, amber light and a green light, although combinations of these and variations on these are possible. From the stress state of the grid, the output condition can be determined. For example, if the grid is in crisis, the display shows red, whereas if the grid is under stress, the indicator shows amber.

The second input is the current price and this can also be provided from the responsive controller. If the grid is otherwise normal, and the current price is below a threshold, then the indicator shows green. It is a good (or at least reasonable) time to run an appliance, such as a kettle. If the price is above the threshold, the indicator will show amber. It may be useful for the indicator to flash amber to indicate that it is a price advice, rather than system stress advice.

If the grid is in crisis, so the light is showing red, and there is a disconnect switch associated with the device, then the disconnect switch will be operated, and the load disconnected. The red light could then flash. If the user presses the override button 95, then the load will be reconnected for a period, but if the grid is still in crisis at the end of the period, the load will again be disconnected.

The profile sharing channels are a feature of many of the preferred components of the control apparatus. They are the various means by which suppliers and other market-makers communicate their preferences to consumers. This communication will normally be via the optimisation support systems of the suppliers and market-makers (which are discussed below), so the channels are computer to computer communications methods. Various example technical means of communication are presently discussed.

Within a household or larger site, there may be more local means of communication among appliances, and a richer set of information communicated. This will be discussed below.

The communications channels should be protected from subversion by anybody who wishes to harm the scheme, or the utility system as a whole. This protection can be by cryptographic means. One possible way of providing protection is described.

Envisaged channels are broadcast channels, which are, by their nature, open. That is, there is no harm to the system from unintended recipients receiving the information broadcast. Indeed, if there are competitive suppliers, each with their own channels, then competitors may legitimately seek to receive and analyse each others profiles, and will use this as one element of the information used in setting their own profiles.

However, recipients of the profiles need to have high confidence that the profile information they receive is from the source claimed.

One way of doing this is for each recipient device to have built in one (or more) public keys to a regulatory sub-channel. This allows the regulatory sub-channel to be protected and authenticated. The regulatory sub-channel will itself then contain public authentication keys for the authorised profile channels, and the users may, if they wish and the service is available, choose a profile from among them.

There is a possibility that an enemy organisation will wish to damage the electricity system of a country or a region, and will aim to attack the system by a sudden release of a full set of subverted preference profiles, designed to destabilise the system rather than optimise it. With current cryptographic methods, this is likely to require very substantial resources devoted to cryptanalysis, and so is probably only open to governments.

One way to reduce this risk is for different classes of appliances or devices, perhaps from different manufacturers, to have different sets of regulatory sub-channel public authentication keys. To achieve the subversion, a larger set of public authentication keys would have to be cracked.

In practice, subversion of the behaviour of even quite large numbers of appliances is unlikely to be an effective or efficient sabotage of the system as a whole. People, in the form of users, remain in the loop, and can be influenced by other media too, for example, abstain from using their appliances, or to just operate them manually. In disruption, it would perhaps be equivalent to that of a successful hidden internet virus attach that succeeds in subverting large numbers of PCs.

Nevertheless, when there is large scale implementation, it may be desirable to have some fallback communications plan to use the physical profile sharing mechanism that is not subject to such communications subversion. One way to prepare for this is to have a public authentication keys to a sub-channel that is only accessible by a physical connection to a device, such as a USB.

We turn now to the possible communications channels.

One example communications channels is a channel at the factory communicating the preference profiles there. A factory preset would be a simple general profile set in the factory, and repeating into the indefinite future. For example, a preference for a dishwasher to run between 1 and 5 am would provide value to the network, and this might be reflected in a lower cost of purchase for the consumer. This is the simplest and most straightforward communications channel, but it is unable to reflect changes as the electricity system evolves and the preferences change. It is also unable to reflect the specific preferences of the supplier providing the electricity to the householder with the appliance.

Another example would be to preset the profile at purchase time. A purchase time preset would involve the (appliance) retailer setting the profile (via a physical communications channel) as part of the delivery processes. This gives an opportunity to take into account: the location or area where the device is likely to be used; the particular supplier serving the customer; and customer's preferences and/or default preferences. In this case, a retailer's optimisation support system will generate and install the profile.

Purchase time is also a time when the possible value of the optimisation to the supplier, the customer and others can be assessed (albeit perhaps imperfectly) and this value can be reflected in the transaction and related electricity supply contracts.

Another possibility is for the update to be performed by a manual update, perhaps through a home energy management system. One way this could be achieved is using a memory stick with a USB plug, and fitting appliance or flow and cost meters with USB ports. Information from the appliance can then be passed to a home PC, further passed over the internet to an appropriate optimisation support system, which, in turn, may tune and re-optimise the profile, and, using the same channel pass a preference profile file back into the appliance. This channel has the benefit of allowing information about the use of the appliance to play a role in any re-optimisation, and perhaps, is setting some tariff parameters, and so rewarding the householder.

The manual update mechanism also provides a fallback communications channel that cannot be subverted en masse, and so can be used to recover in the case of such a cyber attack on the country.

The most preferred method is by broadcast. One or more preference profiles with parameter are broadcast and received by a large number of appliances and flow and cost meters. In many circumstances, there will be one preference profile with parameters for each supplier. The receiving devices select the relevant preference profile and authenticate and decode them.

There are a variety of broadcast tools over which relatively low volume profiles and associated parameters can be transmitted. In the UK this includes the BBC long wave transmission. It may be possible to carry the information on some of the broadcast time and location channels. FM and digital radio offer much higher bit rates, with more selective coverage, and so offer a useful alternative. The appliance or meter may need to be appropriately positioned to enhance reception, or have an external antenna (which may be remote from the meter site).

One of the features of broadcasting is that an individual receiver may not receive or successfully decode a transmitted signal, yet the transmitter cannot be made aware of this failure, and so cannot be asked to retransmit. In part this problem can be addressed by measures in the communications channel. For example, forward error correction means could be included, whereby there is sufficient redundancy in the broadcast message for individual errors to be both detected, and up to limits, corrected.

Another possibility is to have diversity in reception, perhaps through two antenna or reception systems, or by retransmission periodic intervals. In this way, the system and the reception and fitting standards can be engineered to achieve a defined reliability of reception of profile.

There remains the possibility that a meter or appliance will not receive the latest update. This can be managed by the meter or appliance triggering a warning light or other alarm if reception has been impaired for an unacceptably long time. Further, time related profile transformation parameters could be used, so that, if the profile is not updated, appliances will continue to work according to the last received profile, but the “margins” will widen, so making consumption more costly, and rewarding generation less. The general aim will be to make it attractive for both suppliers and consumers to have the reception fixed, with reduced risk of inappropriate cost to the supplier, and reduced cost (or increased reward) to the consumer.

Another alternative is by two way communication. By this, the optimisation support system has some sort of direct, bilateral communication with the control apparatus or meter, and so can communicate, internet style, with it. If the communication fails, both parties are aware of the failure, and either side can take steps to overcome the problem. The internet is, however, only one of the possible communications. Mobile phone data or text messages are both feasible channels, and it may be via a relay in the house or the site, so the final link with the device is via Bluetooth or Zigbee.

A benefit of two way communication is that the control apparatus or meter can also pass information about its operation to the optimisation support system, and so there is a meter reading channel.

Apart from the potential cost, a problem with two way communication is the need to update a lot of devices simultaneously, whenever the profile is to be updated, which may be burdensome.

The above given example communication channels are not mutually exclusive, and an individual appliance may include one, several or all of them.

There is the possibility that the control apparatus and an associated flow and cost meter will not both manage to update the latest preference profile, and so the costs assumed by a control apparatus and the costs calculated by the flow and cost meter are not the same. This can most easily be avoided by making the flow and cost meter a relay for the preference profile communications, with higher reliability, but lower cost communications channels being used for the local communications.

In order to update a preference profile, the following example sets of data could be used. The preference profile itself, with its structures as discussed earlier and a set of parameters to enable transformation of the preference profile into useful information.

In one embodiment, the parameters will be fixed, and only the preference profile needs to be communicated. The preference profile data can be encoded and compressed using any appropriate language or communications scheme. It may, however, be valuable to transmit the updated preference profile with a set of updated parameters.

It is anticipated that updates could be transmitted in the form of XML statements, using a subset of the available features to be parsed within the preference channel reception subsystem 54.

In one preferred embodiment, the issuance of a preference profile by a supplier is an offer to trade at a published price. The supplier has become a market-maker, and so has an exposure to what happens over the future lifetime of the validity of the profile. Their revenue will be determined by the flow and cost meters using the profile, and their customers will be influenced by it.

The costs of the supplier will be influenced by the contracts they have for supply of electricity to their customers, or by their purchases in the spot market. In some cases, and depending upon the operations rules of the areas, purchases or sales in the spot market will be involuntary, deemed to have arisen as a direct consequence of their customers behaviours.

Offering future prices for trade is a risk bearing activity. If the purchase contracts match the consumption, and there is an adequate margin between the buying contracts and selling price from the preference profile, then it is profitable. If, on the other hand, consumption is more than anticipated, and there are late or deemed purchases on the spot market, money might be lost. Equivalently, a well chosen profile may widen the margins, and make for unexpected profits.

The risks are manageable and the supplier is in the best position to manage them. They can know better than any other party, the likely response of their customers to changes in price embodied in the preference profile. They can know their contract position, and they can trade on the wholesale electricity markets, in order to bring their contract position into balance.

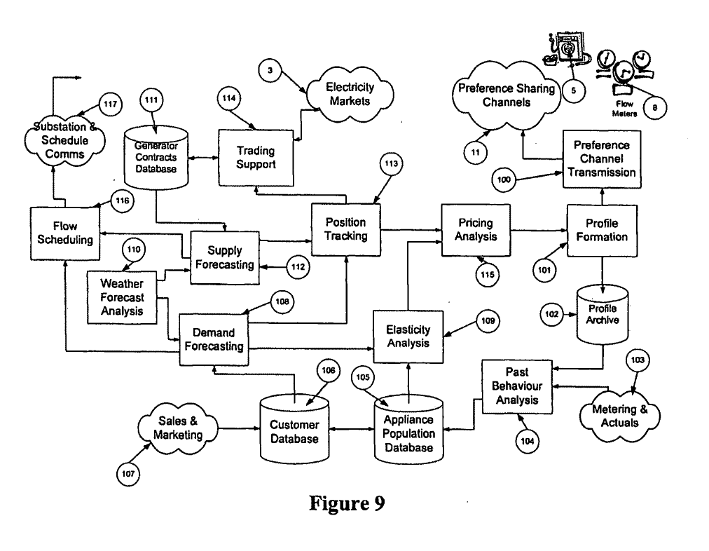

FIG. 9 shows the features of an example optimisation support system. An optimisation support system 10 is an information system to support this risk management and trading activity, prepare the preferences, and transform the preferences into preference profiles for communication to their customers.

The optimisation support system 10 is the collection of information stores and processing subsystems that lead to the formation of a preference profile and its associated parameters.

The appliances 5, flow and cost meters 8 and the preference sharing channels 11 are as previously described, and provide the communications channels to the large population of devices that the system wishes to optimise.

A preference channel transmission 100 is provided and includes technologies necessary to transmit the preference profiles formed by profile formation 101 to the appliances and flow and cost meters.

The transmitted profiles may also be archived 102 so as to allow analysis of the outcomes as these become known through the separate processes of collecting and metering actual data 103. The past behaviour analysis 104 feeds a database characterising the population of appliances 105.

The appliance population database 105 may be updated from changes to the customer database 106, which, in turn, is updated by the sales and marketing activities 107 of the supplier.

The customer database 106 provides input to demand forecasting 108, which makes an assessment of the expected future demand. The output from demand forecasting is made available to the elasticity analysis subsystem 109. Weather forecasts provide an indication of the amount of natural electricity supply that is to be expected and thus are valuable inputs to demand forecasting 108 and are analysed by the weather forecast analyser 110.

The optimisation support system maintains a database of supply contracts 111, which is used by supply forecasting 112 to form forecasts of available supply. Some of these contracts will be for ambient generation, and so will be moderated by the embodiments of the weather that influence generation.

The demand and supply forecasts are input to a position tracking subsystem 113, which provides assessments of whether the supplier is long or short. This information is passed to trading support 114, which will facilitate activity in the electricity markets 3 to ensure a balance of contracts. Trading will lead to changes in the generator contracts database 111, and these will, in turn, update the overall position. Position tracking 113 will also feed to pricing analysis 115, which, taking into account information from elasticity analysis 109 will develop the future price position, which will, after transformation, be communicated to customers.

The supply and demand forecasts may also feed into a flow scheduling system 116. Depending on the trading arrangements, it may be the flow scheduling system 116 that notifies any central system (such as a system operator) of plans at “gate closure”.

The description has thus far, in the most part, been given with reference to the resource being electricity. However, the control system is useful in a wider sphere, particularly utilities, and may be applicable to many markets. By way of substantiation, potential uses with other utilities is given.

Gas is one other potentially suitable market. Like electricity, gas markets are characterised by large numbers of domestic meters measuring consumption over a period far longer than the associated wholesale markets.

Water is another. Water demand varies daily (with daily peaks); seasonally, with scarcity in some seasons; and inter-annually, with drought years. Domestic metering is not, however, yet the norm.

Heat distribution, may also be a potential application, particularly in conjunction with local combined heat and power plants. Such a plant offers opportunities for substantial emissions savings, but, in conjunction with electricity, demands complex optimisation tradeoffs with demands coming at different times of day. In this case storage—usually in the form of hot water—may be centralised or distributed, or both and so needs to be incorporated into the optimisation approach. Similarly, cooling, which may be more efficiently formed from otherwise unused heat, and may be treated in the same way.

Telecoms utilities may be another application area. They have long implemented variable tariffs to encourage a balance across the capacity of the infrastructure and the overall demand. Some further optimisation may become possible if the tariffs can more reliably reflect the current state of the network, and help shift demand from peaks to less busy times.

Road space or rail track space may be another application area. For roads, small changes in traffic at the relevant times can produce big reductions in congestion and so associated costs. So influencing the time of journeys by changing the price paid according to the time of day, and having a plurality of local price zones, each with their own preference profile can allow users to plan their journeys for times and routes that minimise the overall congestion, and so benefit the users as well as other users by optimising the system as a whole.

These will be discussed in turn in more detail below.

Domestic tariffs for gas are constrained by the metering in use, and generally record cumulative consumption over long periods, such as a month, a quarter or longer. Yet wholesale gas prices vary considerably on a day to day basis, and are even volatile within a day. However, there is inherent storage in the distribution system, and thus buffering, so a settlement period of around 24 hours provides adequate time discrimination in the markets. There is thus little benefit in shifting demand around within the day. Rather benefit arises from displacing from one day to another, or from encouraging change in total consumption based on a daily price.

Gas appliances are primarily boilers and domestic fires. When used in this way, individual domestic gas users have relatively little discretion about shifting demand, so the primary impact will be to discourage consumption on high price days.

If, however, the gas is used in some sort of multi-generation system, such as for electricity in a micro combined heat and power appliance, there can be trade-offs between heat and electricity to be optimised. These are likely to be substantially greater if there is some sort of heat distribution infrastructure, and/or if there is a significant storage of heat. Heat is discussed further below.

There are some transmission constraints, which may influence the relative attraction of major gas injection locations: The critical need to ensure that there is always pressure in the distribution network (because of the critical safety implications from re-pressurising) may make short term, or even local price “spikes” a useful mechanism. This suggests a Δt of around half an hour.

Gas has no equivalent of ambient generators. It is always produced from prime sources, or by release from storage in some form.

Opportunities for price updating appear to primarily involve refreshing the preference profile.

Major price variations are hard to predict very far ahead, and often arise from short term contingencies, such as damage to infrastructure or changes in weather. Daily updating of preference profiles looks to be the most useful rate of change.

Water is rarely traded on wholesale markets, although there is a possibility of a “water grid” making inter-regional trading possible. What an appropriate settlement period could be is not clear.

Some water consumption optimisation can arise from changes over three timescales as discussed below.

A first timescale is within the day, as there are peak demand times and the infrastructure capacity may not need to be so great if this demand could be spread over a longer period.

A second is seasonally, as water is more plentiful during a rainy season (often the winter in the UK), and scarce during the summer.

A third is inter-annually, as drought years can be easier to cope with if consumption is discouraged during droughts.

The choice of Δt will depend upon which of these optimisations is most pressing, so between 10 minutes or 1 week. However, price variations within the day are likely to be predictable for some time ahead—weeks, months or even years, so placing limited demands on the profile sharing channels.

Water can be and is stored at several points in its distribution network, including in households. There may be benefit in optimising the timing of this storage.

Broadly, the water equivalent of appliances will be storage tanks, where there is discretion as to when they are topped up. Irrigation systems may also usefully be considered as appliances.

Heat Distribution infrastructures can take heat from distributed generation (combined heat and power) and use it to displace heat generated from fuel closer to where it is used. So a hot water distribution system can remove the need for a gas boiler and so avoid the fuel costs (and emissions) that arise from it.

This raises a set of optimisation issues about the timing of generation and the timing of heat consumption. Often these demands do not arise at the same time, so either electricity has to be generated (at low price times) in order to meet the heat needs, or the heat has to be generated (and perhaps lost) at times when the price of electricity is high so it is profitable to generate.

Clearly, if storage of heat is available, an optimised system would balance the storage of heat with the most profitable electricity generation.

So there are two, inter-dependent systems to be optimised, electricity and heat, each, potentially, including multiple generation and multiple storage appliances.

The equivalents to appliances in this case are combined heat and power systems and each system will have its own set of preference profiles.

In such circumstances, the Δt for the heat preference profile of around 10 minutes looks useful. This is shorter than any inherent lags in the system, but small enough to fine tune the consumption load.

Similar considerations could apply where there is a cooling distribution infrastructure.

Telecoms utilities have long implemented variable tariffs to encourage a balance across the capacity of the infrastructure and the overall demand. Some further optimisation may become possible if the tariffs can more reliably reflect the current state of the network, and help shift demand from peaks to less busy times.

In this market, the appliance is an information appliance of some sort: a phone, a PC, a PDA or entertainment devices, such as TV, radio or gaming console.

The commodity is information transmission quantified as a kbyte, Mbyte or Gbyte.

Some information appliances can have opportunities to shift transmission/reception need through time—much (but not all) is inherently storable, with little cost associated with delay. Clearly, phone calls, and live TV have much more limited storage possibilities. DVD programmes, songs, games, documents (including TV snippets), and software updates are rarely sensitive to delays, even of some hours.

So, by varying the price, telecoms utilities have means to influence the demand, and thus make maximum use of the infrastructure capability they have built.

In such circumstances, the “distribution network” could also become the “control network” for the preference profiles, although the integrity of the control may need it to be logically segregated. The role of the flow and cost meter would remain, although there is the possibility of this being located within the network, rather than in the household.

The storage inherent in a packet routed network probably allows a longer Δt than for electricity networks. One minute looks to be useful, but shorter may allow more rapid reaction to contingencies.

Road networks, are a shared infrastructure, traditionally funded by levies on users (and the taxpayer) in ways that are not influenced by time of day, or the congestion on the route. Apart from the costs to the users of delays from congestion, and the unpredictability of journey times, there are no incentives to shift travel from peak to less peak times.

Yet quite small reductions in traffic at peak times can significantly reduce congestion. Keeping the traffic demand to just below the maximum carrying capacity of a road or route maximises the throughput, yet moving to just above this threshold introduces instabilities, and can quite dramatically slow down a journey and reduce the overall throughput. The London charging scheme has reduced congestion far more than it has reduced total traffic, and all road users (including bus travellers) have benefited.

So road pricing schemes are being considered, whereby travel on roads or routes will form the basis of a charge for the use of the road. This is, for example, the basis of the German lorry charging scheme. These are generally implemented by on-board controllers which use satellite navigation systems to track the use made of roads, accumulate the charges, and report these charges to the relevant authorities. It is a form of meter. A variety of associated systems for enforcement and payment are also necessary.

Different roads or different parts of the network (or parking resource) can have different prices. These prices vary according to periods within the day, so are fixed according to the expected traffic flows. These prices can effectively be carried by preference profiles, with individual preference profiles being associated with a road or portion of the network. So the preference profiles can reflect the dynamic situation, and be adjusted, for example, to take into account planned roadwork or increasing traffic demand.

Users of the roads will receive the preference profiles of the roads or portions of the network over which they plan to travel or park. This becomes a further set of parameters used by navigation planning devices to select an optimum route, although there is now the possibility of planning an optimum time for the journey, with chosen deadlines, as well as just the optimum route.

Because the road preference profiles can be updated dynamically, they can be changed in response to unexpected events, such as a road traffic accident, a flood or other impairment of the network carrying capacity. This will give travellers the best possible information for them to re-plan their journeys in the light of the event and their own circumstances and needs.

It may also be useful to implement a fixed price journey plan, whereby a traveller, having chosen a route, can buy the capacity in advance (for a premium), and so be given preferential access to the route in case of congestion. Similarly, when the throughput of a road is impaired, the price of using it can be raised so as to discourage all but the most valuable traffic.

Similar approach can be used in other network systems that might be subject to congestion. So electricity transmission networks, railways, air traffic can all be enhanced.

The control, particularly in its preferred forms, aims to smooth the variation over time of the consumption of a resource by a population of appliances. This is achieved by timing, or providing the user with information concerning, and the option of controlling, the appliance's consumption of the resource to occur at an optimal time with respect to carrying out a function (preferably within a reasonable time) and also consuming the resource at times of low demand by the network. This provides cost benefits to the user of the appliance and also benefits the resource provider and the network as a whole.

1. An apparatus for monitoring use and/or provision of a resource and/or a service by a user and/or provider of the resource and/or service, said apparatus comprising means for receiving data indicative of the benefit of operating the user and/or provider at one or more particular future times and/or one or more particular future operating conditions; means for monitoring use and/or provision of the resource or service by the user or provider; and means for outputting information indicative of a cost of said use and/or provision based on said data.

2. The apparatus of claim 1, wherein said apparatus comprises means for determining the cost of said use or provision based on said data.

3. The apparatus of claim 2, wherein said apparatus comprises a display and means for outputting the cost of use or provision to the display.

4. The apparatus of claim 2, comprising means for receiving further data concerning the state of a network for distributing the resource, means for deriving a cost of use or provision based on said further data, and means for providing an output indicating a comparison of said costs.

5. The apparatus of claim 1, wherein said user or provider is an appliance or device.

6. An apparatus for allowing optimisation of use or provision of a resource and/or service based on input data indicative of the benefit of using and/or providing the resource and/or service at one or more particular future times and/or under one or more particular future operating conditions.

7. The apparatus of claim 6, comprising means for monitoring use and/or provision of the resource or service by an appliance or device; comprising means for receiving data indicative of the benefit of operating the appliance or device at one or more particular future times and/or under one or more particular future operating conditions and means for outputting information indicative of a cost of said use and/or provision based on said data.

8. The apparatus of claim 6, wherein the apparatus is for optimising the use or provision of a resource and the resource is electricity.

9. The apparatus of claim 6, wherein the apparatus is for optimising the use of a service and the service is a road network.

10. The apparatus of claim 5, comprising means for setting the timing of operation of the appliance or device based on said data

11. The apparatus of claim 6, wherein the apparatus is for controlling operation of an appliance or a device that uses and/or provides the resource or the service, said apparatus comprising means for receiving data indicative of the benefit of operating the appliance or device at one or more particular future times and/or under one or more particular future operating conditions and means for allowing the timing of operation of the appliance or device to be set based on said data.

12. The apparatus of claim 11, comprising means for setting the timing of operation of the apparatus or device based on said data.

13. The apparatus of claim 10, wherein said means for setting comprises means for determining the cost of operating the appliance or device based on said data and wherein said means for setting sets said timing in response to said cost.

14. The apparatus of claim 12, wherein said means for setting is a user response to outputted benefit data.

15. The apparatus of claim 10, wherein said indication of benefit at future times is transformable to prices of the resource at future times.

16. The apparatus of claim 10, wherein the indication of benefit at future times is an indication of price at future times.

17. The apparatus of claim 10, comprising means operable by a user for setting a deadline for provision or use of the resource or service.

18. The apparatus of claim 10, comprising means for outputting a control signal to the appliance or device to execute the provision or use based on said set time.

19. The apparatus of claim 10, comprising user input means for inputting a plurality of preferred times for said use or provision to take place and means for determining a price of operating said appliance or device for each of said plurality of times based on said data and a display means for outputting the prices.

20. The apparatus of claim 10, wherein said indication of a benefit comprises a plurality of numbers representing the benefit, each number associated with a time, the times regularly or irregularly spaced and extending into the future.

21. The apparatus of claim 10, wherein said means for setting the timing includes means for determining a plurality of times for commencement of use or provision based on said data and means for selecting one of these times at random as the timing of operation of the appliance or device.

22. The apparatus of claim 10, comprising means for accessing a use or provision profile representative of use or provision of the resource or service for a given function of the appliance or device, wherein the means for setting a timing of operation of the appliance or device is further based on said use or provision profile.

23. The apparatus of claim 22, wherein the profile comprises a plurality of numbers representing a quantity of use or provision in performing said function, each number associated with a time, the times regularly or irregularly spaced and extending the duration of the function.

24. The apparatus of claim 22, comprising means for calculating a cost for performing said function, the cost being calculated using the use or provision profile and the indication of benefit at a future time and wherein said means for setting a timing of operation of the appliance or device comprises a means for outputting a use or provision plan by optimising the cost with respect to time, said use or provision plan setting said timing.

25. The apparatus of claim 22, wherein the spacing of the times for the indication of benefit and the use or provision profile is the same.

26. The apparatus of claim 22, wherein the function comprises a number of segments, the means for setting a timing of operation of the use or provision comprising means for setting a delay between at least two of the segments based on said data.

27. The apparatus of claim 10, comprising means for receiving inputs indicative of the benefit of using and/or providing the resource and/or service at one or more particular future times and/or under one or more particular future operating conditions from a plurality of retailers, wherein said means for setting further comprises means for setting the retailer to provide the service or resource for performing the provision or use.

28. The apparatus of claim 27, comprising means for metering the use or provision of the resource or service so as to identify amounts of use or provision of the resource or service against the retailer of the resource or service.

29. The apparatus of claim 10, wherein the resource is electricity and the apparatus further comprises means for detecting a frequency of the grid and means for interrupting a function being performed by the appliance or device or re-setting the timing for operating the appliance or device based on the frequency of the grid.

30. The apparatus of claim 29, comprising means for transforming the frequency of the grid to a present price and means for transforming the indication of a benefit to a predicted price and wherein said means for interrupting or means for resetting output an interruption or reset signal if the predicted price is beyond a threshold amount from the present price.

31. The apparatus of claim 29, wherein said means for interrupting or resetting output an interruption or reset signal if the frequency of the grid is outside acceptable values.

32. The apparatus of claim 10, comprising means for receiving updates to said indication of the benefit.

33. The apparatus of claim 32, wherein said updates are received over the air.

34. The apparatus of claim 32, comprising means for re-setting said timing of operation of said appliance or device based on said updated indication of the benefit.

35. The apparatus of claim 10, comprising means for metering the use or provision of the resource or service, means for storing the metered amount of use or provision and means for storing the indication of a benefit upon which the timing of the use or provision was based.

36. The apparatus of claim 35 comprising means for transmitting the stored information.

37. An appliance or device that uses and/or provides a resource and is responsive to the apparatus of claim 1.

38. A system comprising and appliance or device that uses or provides a resource or service, a retailer of the resource or service and the apparatus of claim 1.

39. The system of claim 38, wherein the retailer provides the indication of a benefit.

40. The system of claim 38, wherein the retailer comprises means for transmitting the indication of a benefit over the air as a first indication.

41. The system of claim 40, comprising at least one further retailer of the resource or service comprising means for transmitting the indication of a benefit over the air as a second indication and wherein the apparatus comprises means for selecting which retailer's service or resource to operate the appliance or device with.

42. A method of monitoring use and/or provision of a resource and/or a service by a user and/or provider of the resource and/or service, said method comprising receiving data indicative of the benefit of operating the user and/or provider at one or more particular future times and/or one or more particular future operating conditions; monitoring use and/or provision of the resource or service by the user or provider; and outputting information indicative of a cost of said use and/or provision based on said data.

43. The method of claim 42, wherein said method comprises determining the cost of said use or provision based on said data.

44. The method of claim 43, wherein said method comprises outputting the cost of use or provision to a display.

45. The method of claim 43, comprising receiving further data concerning the state of a network for distributing the resource, deriving a cost of use or provision based on said further data, and providing an output indicating a comparison of said costs.

46. The method of claim 42, wherein said user or provider is an appliance or device.

47. A method of allowing optimisation of use or provision of a resource and/or service based on input data indicative of the benefit of using and/or providing the resource and/or service at one or more particular future times and/or under one or more particular future operating conditions.

48. The method of claim 47, comprising monitoring use and/or provision of the resource or service by an appliance or device; comprising receiving data indicative of the benefit of operating the appliance or device at one or more particular future times and/or under one or more particular future operating conditions and outputting information indicative of a cost of said use and/or provision based on said data.

49. The method of claim 47, wherein the method is for optimising the use or provision of a resource and the resource is electricity.

50. The method of claim 47, wherein the method is for optimising the use of a service and the service is a road network.

51. The method of claim 46, comprising setting the timing of operation of the appliance or device based on said data.

52. The method of claim 47, wherein the method is for controlling operation of an appliance or a device that uses and/or provides the resource or the service, comprising receiving data indicative of the benefit of operating the appliance or device at one or more particular future times and/or under one or more particular future operating conditions and allowing the timing of operation of the appliance or device to be set based on said data.

53. The method of claim 52, comprising setting the timing of operation of the apparatus or device based on said data.

54. The method of claim 51, wherein said setting comprises determining the cost of operating the appliance or device based on said data and said setting sets said timing in response to said cost.

55. The method of claim 53, wherein said setting is a user response to outputted benefit data.

56. The method of claim 51, wherein said indication of benefit at future times is transformable to prices of the resource at future times.

57. The method of claim 51, wherein the indication of benefit at future times is an indication of price at future times.

58. The method of claim 51, comprising a user setting a deadline for provision or use of the resource or service.

59. The method of claim 51, comprising outputting a control signal to the appliance or device to execute the provision or use based on said set time.

60. The method of claim 51, comprising a user inputting a plurality of preferred times for said use or provision to take place and determining a price for operating the appliance or device at each of said plurality of times based on said data and a display means for outputting the prices.

61. The method of claim 51, wherein said indication of a benefit comprises a plurality of numbers representing the benefit, each number associated with a time, the times regularly or irregularly spaced and extending into the future.

62. The method of claim 51, wherein said setting the timing includes means for determining a plurality of times for commencement of use or provision based on said data and selecting one of these times at random as the timing of operation of the appliance or device.

63. The method of claim 50, comprising accessing a use or provision profile representative of use or provision of the resource or service for a given function of the appliance or device, wherein the setting a timing of operation of the appliance or device is further based on said use or provision profile.

64. The method of claim 63, wherein the profile comprises a plurality of numbers representing a quantity of use or provision in performing said function, each number associated with a time, the times regularly or irregularly spaced and extending the duration of the function.

65. The method of claim 63, comprising calculating a cost for performing said function, the cost being calculated using the use or provision profile and the indication of benefit at a future time and wherein said setting a timing of operation of the appliance or device comprises a outputting a use or provision plan by optimising the cost with respect to time, said use or provision plan setting said timing.

66. The method of claim 63 wherein the spacing of the times for the indication of benefit and the use or provision profile is the same.

67. The method of claim 63, wherein the function comprises a number of segments, the setting a timing of operation of the use or provision comprising setting a delay between at least two of the segments based on said data.

68. The method of claim 51, comprising receiving inputs indicative of the benefit of using and/or providing the resource and/or service at one or more particular future times and/or under one or more particular future operating conditions from a plurality of retailers, wherein said setting further comprises setting the retailer to provide the service or resource for performing the provision or use.

69. The method of claim 68, comprising metering the use or provision of the resource or service so as to identify amounts of use or provision of the resource or service against the retailer of the resource or service.

70. The method of claim 51, wherein the resource is electricity and the method further comprises detecting a frequency of the grid and interrupting a function being performed by the appliance or device or re-setting the timing for operating the appliance or device based on the frequency of the grid.

71. The method of claim 71, comprising transforming the frequency of the grid to a present price and transforming the indication of a benefit to a predicted price and wherein said interrupting resetting output an interruption or reset signal if the predicted price is beyond a threshold amount from the present price.

72. The method of claim 70, wherein said interrupting or resetting output an interruption or reset signal if the frequency of the grid is outside acceptable values.

73. The method of claim 51, comprising receiving updates to said indication of the benefit.

74. The method of claim 73, wherein said updates are received over the air.

75. The method of claim 73, comprising re-setting said timing of operation of said appliance or device based on said updated indication of the benefit.

76. The method of claim 50, comprising metering the use or provision of the resource or service, storing the metered amount of use or provision and storing the indication of a benefit upon which the timing of the use or provision was based.

77. The method of claim 76 comprising transmitting the stored information.

78. The method of claim 42, wherein a retailer of the resource or service provides the indication of a benefit.

79. The method of claim 78, wherein the retailer transmits the indication of a benefit over the air as a first indication.

80. The method of claim 79, wherein at least one further retailer of the resource or service transmits the indication of a benefit over the air as a second indication and wherein the method comprises selecting which retailer's service or resource to operate the appliance or device with.
